(19) United States
(12) Patent Application Publication
(10) Pub. No.: US 2026/0222841 A1
(43) Pub. Date: Jul. 30, 2026

(54) ASSISTED MEASUREMENT PROCEDURE UNDER NTN DISCONTINUOUS COVERAGE

(71) Applicant: Telefonaktiebolaget LM Ericsson (publ), Stockholm (SE)

(72) Inventors: Ignacio Javier Pascual Pelayo, Stockholm (SE); Santhan Thangarasa, Vällingby (SE); Muhammad Kazmi, Sundbyberg (SE); Ming Li, Stockholm (SE)

(21) Appl. No.: 19/150,474

(22) PCT Filed: Feb. 16, 2024
(86) PCT No.: PCT/IB2024/051509

§ 371 Date: Jul. 23, 2025

Related U.S. Application Data
(60) Provisional application No. 63/446,148, filed on Feb. 16, 2023.

(51) Int. Cl. H04W 24/02; H04W 84/06

(52) U.S. Cl. CPC H04W 24/02; H04W 84/06

(57) ABSTRACT

Systems and methods for assisted operational procedures under Non-Terrestrial Network (NTN) discontinuous coverage are provided. In some embodiments, a method performed by a User Equipment (UE) for adapting one or more operational procedures includes: determining, based on cell assistance information, whether at least two cells of a plurality of cells meet one or more measurement similarity conditions. In response to determining that the at least two cells of the plurality of cells meet the one or more measurement similarity conditions, the UE adapts one or more operational procedures. This might enable smooth transition of the ongoing communication/session across cells served or managed by satellites in discontinuous coverage scenario. This enables UE power saving as it searches only the cells which are likely available at the UE location upon resumption of the satellite coverage. This avoids or minimizes the loss of paging reception upon resumption of the satellite coverage.

### RELATED APPLICATIONS

This application claims the benefit of provisional patent application Ser. No. 63/446,148, filed Feb. 16, 2023, the disclosure of which is hereby incorporated herein by reference in its entirety.

### TECHNICAL FIELD

The present disclosure relates generally to measurement procedures.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

In 3GPP, 5G system (5GS) is a new generation's radio access technology intended to serve use cases such as enhanced mobile broadband (eMBB), ultra-reliable and low latency communication (URLLC), NB-IOT and mMTC. 5G includes the New Radio (NR) access stratum interface and the 5G Core Network (5GC). The NR physical and higher layers are reusing parts of the LTE specification, and to that add needed components when motivated by new use cases. To benefit from the strong mobile ecosystem and economy of scale, the satellite network based on the terrestrial wireless access technologies including LTE and NR for satellite networks, is being specified in the 3GPP standard.

### IoT NTN and NTN Characteristics

A satellite radio access network usually includes the following components:
A satellite that refers to a space-borne platform.
An earth-based gateway that connects the satellite to a base station or a core network, depending on the choice of architecture.
Feeder link that refers to the link between a gateway and a satellite
Access link, or service link, that refers to the link between a satellite and a UE.

Depending on the orbit altitude, a satellite may be categorized as low earth orbit (LEO), medium earth orbit (MEO), or geostationary earth orbit (GEO) satellite.
LEO: typical heights ranging from 250-1,500 km, with orbital periods ranging from 90-120 minutes.
MEO: typical heights ranging from 5,000-25,000 km, with orbital periods ranging from 3-15 hours.
GEO: height at about 35,786 km, with an orbital period of 24 hours.

A satellite which does not operate in geostationary earth orbit is also broadly called as NGSO (Non-Geostationary Orbit) satellite. Examples of NGSO satellites are LEO and MEO satellites.

Two basic architectures can be distinguished for satellite communication networks, depending on the functionality of the satellites in the system:
Transparent payload (also referred to as bent pipe architecture). The satellite forwards the received signal between the terminal and the network equipment on the ground with only amplification and a shift from uplink frequency to downlink frequency. When applied to general 3GPP architecture and terminology, the transparent payload architecture means that the gNB is located on the ground and the satellite forwards signals/data between the gNB and the UE
Regenerative payload. The satellite includes on-board processing to demodulate and decode the received signal and regenerate the signal before sending it back to the earth. When applied to general 3GPP architecture and terminology, the regenerative payload architecture means that the gNB is located in the satellite.

In the work item for NR NTN in 3GPP release 17, only the transparent payload architecture is considered.

A satellite network or satellite based mobile network may also be called a non-terrestrial network (NTN). On the other hand, a mobile network with base stations on the group may also be called aa terrestrial network (TN) or non-NTN network. A satellite within NTN may be called as NTN node, NTN satellite or simply a satellite.

FIG. 1 shows an example architecture of a satellite network with bent pipe transponders (i.e., the transparent payload architecture). The gNB may be integrated in the gateway or connected to the gateway via a terrestrial connection (wire, optic fiber, wireless link).

A communication satellite typically generates several beams over a given area. The footprint of a beam is usually in an elliptic shape, which has traditionally been considered as a cell, but cells consisting of the coverage footprint of multiple beams are not excluded in the 3GPP work. The footprint of a beam is also often referred to as a spotbeam. The footprint of a beam may move over the earth's surface with the satellite movement or may be earth fixed with a beam pointing mechanism used by the satellite to compensate for the satellite's motion. The size of a spotbeam depends on the system design, which may range from tens of kilometers to a few thousands of kilometers.

In a LEO or MEO communication system, a large number of satellites deployed over a range of orbits is required to provide continuous coverage across the full globe. Launching a mega satellite constellation is both an expensive and time-consuming procedure. It is therefore expected that all LEO and MEO satellite constellations for some time will only provide partial earth-coverage. In the case of some constellations dedicated to massive IoT services with relaxed latency requirements, it may not even be necessary to support full earth-coverage. It may be sufficient to provide occasional or periodic coverage according to the orbital period of the constellation.

A 3GPP device in RRC_IDLE or RRC_INACTIVE state is required to perform a number of procedures including measurements for mobility purposes, paging monitoring, logging measurement results, tracking area update, and search for a new PLMN to mention a few. These procedures will consume power in devices, and a general trend in 3GPP has been to allow for relaxation of these procedures to prolong device battery life. This trend has been especially pronounced for IoT devices supported by reduced capability (redcap), NB IoT and LTE M.

Propagation delay is an important aspect of satellite communications that is different from the delay expected in a terrestrial mobile system. For a bent pipe satellite network, the round-trip delay may, depending on the orbit height, range from tens of ms in the case of LEO satellites to several hundreds of ms for GEO satellites. As a comparison, the round-trip delays in terrestrial cellular networks are typically below 1 ms.

The distance between the UE and a satellite can vary significantly, depending on the position of the satellite and thus the elevation angle & seen by the UE. Assuming circular orbits, the minimum distance is realized when the satellite is directly above the UE (ε=90°), and the maximum distance when the satellite is at the smallest possible elevation angle. Table 1 shows the distances between satellite and UE for different orbital heights and elevation angles together with the one-way propagation delay and the maximum propagation delay difference (the difference from the propagation delay at ε=90°). Note that this table assumes regenerative payload architecture. For the transparent payload case, the propagation delay between gateway and satellite needs to be considered as well, unless the base station corrects for that.

TABLE 1
Propagation delay for different orbital heights and elevation angles

| Orbital | Elevation | Distance | One-way | Propagation delay |
|---|---|---|---|---|
| height | angle | UE <-> satellite | propagation delay | difference |
| 600 km | 90° | 600 km | 2.0 ms | — |
| | 30° | 1075 km | 3.6 ms | 1.6 ms |
| | 10° | 1932 km | 6.4 ms | 4.4 ms |
| 1200 km | 90° | 1200 km | 4.0 ms | — |
| | 30° | 1999 km | 6.7 ms | 2.7 ms |
| | 10° | 3131 km | 10.4 ms | 6.4 ms |
| 35786 km | 90° | 35786 km | 119.4 ms | — |
| | 30° | 38609 km | 128.8 ms | 9.4 ms |
| | 10° | 40581 km | 135.4 ms | 16.0 ms |

The propagation delay may also be highly variable due to the high velocity of the LEO and MEO satellites and change in the order of 10-100 μs every second, depending on the orbit altitude and satellite velocity.

### Ephemeris Data

In TR 38.821, it has been captured that ephemeris data should be provided to the UE, for example to assist with pointing a directional antenna (or an antenna beam) towards the satellite. A UE knowing its own position, e.g., thanks to GNSS support, may also use the ephemeris data to calculate correct timing related and/or frequency drifts e.g., Timing Advance (TA) and Doppler shift. The contents of the ephemeris data and the procedures on how to provide and update such data have not yet been studied in detail.

A satellite orbit can be fully described using 6 parameters. Exactly which set of parameters is used can be decided by the user; many different representations are possible. For example, a choice of parameters used often in astronomy is the set (a, ε, i, Ω, ω, t). Here, the semi-major axis a and the eccentricity ε describe the shape and size of the orbit ellipse; the inclination i, the right ascension of the ascending node Ω, and the argument of periapsis ω determine its position in space, and the epoch t determines a reference time (e.g., the time when the satellites move through periapsis). The set of these parameters is illustrated in FIG. 2.

A two-line element set (TLE) is a data format encoding a list of orbital elements of an Earth-orbiting object for a given point in time, the epoch. As an example of a different parametrization, TLEs use mean motion n and mean anomaly M instead of a and t.

A completely different set of parameters is the position and velocity vector (x, y, z, vx, vy, vz) of a satellite. These are sometimes called orbital state vectors. They can be derived from the orbital elements and vice versa since the information they contain is equivalent. All these formulations (and many others) are possible choices for the format of ephemeris data to be used in NTN.

Additionally, the ephemeris data may be accompanied with information on possible coverage area, or timing information when the satellite is going to serve a certain geographical area on Earth.

### Satellite Discontinuous Coverage

Discontinuous coverage refers to the situation where the visibility of a satellite or group of satellites, commonly Low Earth Orbit (LEO), from a certain ground point is limited in time leading to periods without any satellite network coverage. The rapid movement of NGSO (Non-Geostationary Orbit) satellites around Earth is the cause of this time limitation and its length depends on the characteristics of the satellite constellation (e.g., structure, total number of satellites, number of orbital planes, or satellites per plane) and UE (e.g., minimum elevation angle, or local radio conditions). Hence, the use of partial, sparse, or incomplete constellations where the number of satellites is not enough to provide continuous coverage in a region will result in satellite network coverage gaps. This might be a usual case in early IoT NTN deployments due to the relaxed delay requirements and traffic profiles typical of IoT applications.

During Release 17, a UE centric solution to evaluate coverage gaps was standardized in 3GPP for IoT NTN. The assistance information sent to the UE includes satellite mean ephemeris in Two-Line Element (TLE) format, satellite ID and coverage information. Additionally, in quasi-Earth fixed cell deployments, the network may provide the absolute start serving time (T-service-start) instead of the satellite's ephemeris. This information is used by the UE to estimate when the same or next satellite will be visible from its current location so that it can enter a deep sleep state in between the satellite passes when there is no available coverage.

### SSB-MTC and Measurement Gaps

NR synchronization signal (SS) consists of primary SS (PSS) and secondary SS (SSS). NR physical broadcast channel (PBCH) carries the very basic system information. The combination of SS and PBCH is referred to as SSB in NR. Multiple SSBs are transmitted in a localized burst set. Within an SS burst set, multiple SSBs can be transmitted in different beams. The transmission of SSBs within a localized burst set is confined to a 5 ms window. The set of possible SSB time locations within an SS burst set depends on the numerology which in most cases is uniquely identified by the frequency band. The SSB periodicity can be configured from the value set {5, 10, 20, 40, 80, 160} ms (where the unit used in the configuration is subframe, which has a duration of 1 ms).

A UE does not need to perform measurements with the same periodicity as the SSB periodicity. Accordingly, the SSB measurement time configuration (SMTC) has been introduced for NR. The signaling of SMTC window informs the UE of the timing and periodicity of SSBs that the UE can use for measurements. The SMTC window periodicity can be configured from the value set {5, 10, 20, 40, 80, 160} ms, matching the possible SSB periodicities. The SMTC window duration can be configured from the value set {1, 2, 3, 4, 5} ms (where the unit used in the configuration is subframe, which has a duration of 1 ms). The SMTC window duration may also be called an SMTC duration or SMTC occasion or length in time.

The UE may use the same RF module for measurements of neighboring cells and data transmission in the serving cell. Measurement gaps allow the UE to suspend the data transmission in the serving cell and perform the measurements of neighboring cells. The measurement gap repetition periodicity can be configured from the value set {20, 40, 80, 160} ms, the gap length can be configured from the value set {1.5, 3, 3.5, 4, 5.5, 6, 10, 20} ms. Usually, the measurement gap length is configured to be larger than the SMTC window duration to allow for RF retuning time. Measurement gap time advance is also introduced to fine tune the relative position of the measurement gap with respect to the SMTC window. The measurement gap timing advance can be configured from the value set {0, 0.25, 0.5} ms.

FIG. 3 provides an illustration of SSB, SMTC window, and measurement gap.

### Measurement Rules for NTN in RRC Idle/Inactive State

A UE served by NTN node (e.g., satellite node) applies one or more existing measurement rules defined for legacy UE (i.e., UE served by terrestrial network). The NTN capable UE is also required to perform measurements according to additional rules which are specific to operation in NTN i.e., UE served by the NTN node.

As per TS36.331 V17.3.0, the parameter, ‘t-Service-r17’ is broadcasted by a cell in the system information (SI): SIB3. ‘t-Service-r17’ is the time information on when an NTN quasi-Earth fixed cell served or managed by NTN node is going to stop serving the area which it is currently covering.

To deal with discontinuous coverage provided by limited number of IoT NTN satellites, as per TS36.331 V17.3.0, the parameter, ‘t-ServiceStart-r17’ is broadcasted by a cell in the system information (SI): SIB32. ‘t-ServiceStart-r17’ is the time information on when the incoming satellite is going to start serving the area for quasi-earth fixed satellite.

Bother ‘t-Service-r17’ and ‘t-ServiceStart-r17’ are time offset with respect to the UTC time.

In one example, according to TS 36.304 v17.3.0, if ‘t-Service-r17’ of the serving cell is configured then the UE should start to perform intra-frequency, inter-frequency or inter-RAT measurements before time instant corresponding to ‘t-Service-r17’, regardless of the distance between UE and the serving cell reference location or whether the serving cell fulfils Srxlev>SIntraSearchP and Squal>SIntraSearchQ, or Srxlev>SnonIntraSearchP and Squal>SnonIntraSearchQ and the exact time to start measurement before t-Service is up to UE implementation.

In another example, UE uses ‘t-ServiceStart-r17’ to determine time period of discontinuous coverage, i.e., UE isn't expected to be served by any satellite cell when current time is earlier than time instant corresponding to ‘t-ServiceStart-r17’; subsequently, UE shall perform cell (re) selection, at the least, when current time reaches time instant corresponding to ‘t-ServiceStart-r17’.

### IoT, NB-IoT

The Narrow Band Internet of Things (NB-IoT) is a radio access for cellular internet of things (IoT), based to a great extent on a non-backward-compatible variant of E-UTRA, that addresses improved indoor coverage, support for massive number of low throughput devices, low delay sensitivity, ultra-low device cost, low device power consumption and (optimized) network architecture.

The NB-IoT carrier BW (Bw2) is 200 KHz. Examples of operating bandwidth (Bw1) of LTE are 1.4 MHz, 3 MHz, 5 MHz, 10 MHz, 15 MHz, 20 MHz etc.

### NB-IoT Supports 3 Different Modes of Operation:

1. ‘Stand-alone operation’ utilizing for example the spectrum currently being used by GERAN systems as a replacement for one or more GSM carriers. In principle it operates on any carrier frequency which is neither within the carrier of another system nor within the guard band of another system's operating carrier. The other system can be another NB-IoT operation or any other RAT e.g., LTE.

2. ‘Guard band operation’ utilizing the unused resource blocks within an LTE carrier's guard-band. The term guard band may also interchangeably be called guard bandwidth. As an example, in the case of LTE BW of 20 MHz (i.e., Bw1=20 MHz or 100 RBs), the guard band operation of NB-IoT can place anywhere outside the central 18 MHz but within 20 MHz LTE BW.

3. ‘In-band operation’ utilizing resource blocks within a normal LTE carrier. The in-band operation may also interchangeably be called in-bandwidth operation. More generally the operation of one RAT within the BW of another RAT is also called in-band operation. As an example, in an LTE BW of 50 RBs (i.e., Bw1 of 0 MHz or 50 RBs), NB-IoT operation over one resource block (RB) within the 50 RBs is called in-band operation.

In NB-IoT the downlink transmission is based on OFDM with 15 kHz subcarrier spacing for all the scenarios: standalone, guard-band, and in-band. For UL transmission, both multi-tone transmissions based on CS-FDMA, and single tone transmission is supported.

This means that the physical waveforms for NB-IoT in downlink and also partly in uplink are similar to legacy LTE.

In the downlink design, NB-IoT supports both master information broadcast and system information broadcast which are carried by different physical channels. For in-band operation, it is possible for NB-IoT UE to decode NB-PBCH without knowing the legacy PRB index. NB-IoT supports both downlink physical control channel (NB-PDCCH, or NB-M-PDCCH) and downlink physical shared channel (PDCSH). The operation mode of NB-IoT must be indicated to the UE e.g., in system information such as in NB-MIB. The downlink synchronization signals consist of NB-IoT primary synchronization signal (NPSS) and NB-IoT secondary synchronization signal (NSSS). The downlink reference signal is NB-IoT reference signal (NRS).

Furthermore, in NB-IoT anchor and non-anchor carriers are defined. In anchor carrier the UE assumes that NPSS/NSSS/NPBCH/SIB-NB are transmitted by a base station in the downlink. In non-anchor carriers the UE assumes that NPSS/NSSS/NPBCH/SIB-NB are NOT transmitted by the base station in the downlink. The anchor carrier is transmitted on subframes #0, #4, #5 in every frame and subframe #9 in every other frame. The anchor carriers transmitting NPBCH/SIB-NB contains also NRS. The non-anchor carrier contains NRS during certain occasions and UE specific signals such as NPDCCH and NPDCSH. The non-anchor carrier can be transmitted in any subframe other than those containing the anchor carrier. The resources for non-anchor carrier are configured by the network node. For example, the BS (e.g., eNB) transmits a bit map of DL subframes using IE (DL-Bitmap-NB) which are configured as non-anchor carrier. The anchor carrier and/or non-anchor carrier may typically be operated by the same network node, e.g., by the serving cell. But the anchor carrier and/or non-anchor carrier may also be operated by different network nodes. The configuration of the non-anchor carriers is signaled to the UE via RRC message.

### MTC

The machine-to-machine (M2M) communication (or aka machine type communication (MTC)) is used for establishing communication between machines and between machines and humans. The communication may comprise of exchange of data, signaling, measurement data, configuration information etc. The device size may vary from that of a wallet to that of a base station. The M2M devices are quite often used for applications like sensing environmental conditions (e.g., temperature reading), metering or measurement (e.g., electricity usage etc.), fault finding or error detection etc. In these applications the M2M devices are active very seldom but over a consecutive duration depending upon the type of service e.g., about 200 ms once every 2 seconds, about 500 ms every 60 minutes etc. The M2M device may also do measurements on other frequencies or other RATs.

The MTC device is expected to be of low cost and low complexity. A low complexity UE envisages for M2M operation may implement one or more low-cost features like, smaller downlink and uplink maximum transport block size (e.g., 1000 bits) and/or reduced downlink channel bandwidth of 1.4 MHz for data channel (e.g., PDCSH). A low-cost UE may also comprise of a half-duplex (HD-FDD) and one or more of the following additional features, single receiver (1 Rx) at the UE, smaller downlink and/or uplink maximum transport block size (e.g., 1000 bits) and reduced downlink channel bandwidth of 1.4 MHz for data channel. The low-cost UE may also be termed as low complexity UE.

eMTC

The existing eMTC features include a low-complexity user equipment (UE) category called UE category M1 (or Cat-M1 for short) and coverage enhancement techniques (CE modes A and B) that can be used together with UE category M1 or any other LTE UE category.

All eMTC features (both Cat-M1 and E modes A and B) operate using a reduced maximum channel bandwidth compared to normal LTE. The maximum channel bandwidth in eMTC is 1.4 MHz whereas it is up to 20 MHz in normal LTE. The eMTC UEs are still able to operate within the larger LTE system bandwidth without problem. The main difference compared to normal LTE UEs is that the eMTCs can only be scheduled with 6 physical resource blocks (PRBs) à 180 kHz at a time.

In CE modes A and B, the coverage of physical channels is enhanced through various coverage enhancement techniques, the most important being repetition or retransmission. In its simplest form, this means that the 1-ms subframe to be transmitted is repeated a number of times, e.g., just a few times if a small coverage enhancement is needed or hundreds or thousands of times if a large coverage enhancement is needed.

### Air-to-Ground (ATG)

ATG network is basically utilizing the existing mature terrestrial techniques to build one stereoscopic network to provide high quality service for the airplane user. Meanwhile with the introduction of 5G technologies into ATG network, the user on board could experience the adequate data rates as terrestrial network, therefore the user could have normal online service like online browsing, conference call, real time entertainment and data transmission between cabinets to guarantee the flight safety.

ATG BS is much more powerful than the legacy terrestrial BS since its coverage range could increase up to 200 km shown in FIG. 4 compared with cell coverage up to hundreds of meters of the legacy terrestrial BS. In addition, ATG BS could also support the mobility of airplane up to 1200 km/h which is much faster than high speed train (HST).

Different from the satellite system which occupies the dedicated channel to provide the service, the ATG system could be deployed co-channel with terrestrial network which could better utilize the existing spectrum holding in hand.

In addition, ATG system could provide much higher data rate than satellite system due to its closer distance between BS and UE. In addition, high gain of antenna array equipped on airplane is also part of the reason to achieve better performance.

NR support for non-terrestrial networks (NTN) which includes satellite component has been specified in 3GPP specifications since Rel-17. The NR NTN (non-terrestrial networks) specification includes especially LEO and GEO with implicit compatibility to support HAPS (high altitude platform station) and ATG (air to ground) scenarios. Satellite link focus on providing everywhere connectivity (e.g., when crossing the sea), while ATG link focus on providing high-quality data services for all service available areas (e.g., inland and coastline area). Improved systems and methods are needed for UE operational behavior in discontinuous coverage.

### SUMMARY

Systems and methods for assisted measurement procedure under Non-Terrestrial Network (NTN) discontinuous coverage are provided. In some embodiments, a method performed by a User Equipment (UE) for adapting one or more operational procedures (e.g., measurement procedures) includes: determining whether at least two cells of a plurality of cells meet one or more Measurement Similarity (MS) conditions based on Cell Assistance Information (CAI). In response to determining that the at least two cells of the plurality of cells meet the one or more MS conditions, the UE adapts one or more operational procedures. This might enable smooth transition of the ongoing communication/session across cells served or managed by satellites in discontinuous coverage scenario. The UE measurement behavior is well defined when the UE resumes/re-establishes the communication link upon resumption of the satellite coverage. This enables UE power saving as it searches only the cells which are likely available at the UE location upon resumption of the satellite coverage. This avoids or minimizes the loss of paging reception upon resumption of the satellite coverage.

Certain aspects of the present disclosure and their embodiments may provide solutions to the aforementioned or other challenges. The proposed solution(s) is set(s) of mechanisms for a UE in a first cell (Cell1) served or managed by a first network node (NW1) and a second cell (Cell2) served or managed by a second network node (NW2). The UE is served by Cell1 and Cell2 at different times. Cell1 stops serving the area or zone where the UE is located at a time instance, T-service. Cell2 starts serving the area or zone where the UE is located from time instance, T-service-start.

The network nodes, NW1 or NW2 therein could belong to any type of network among NTN (IoT NTN or NR NTN) network (e.g., UE served by IoT NTN or NR NTN node), TN network or ATG network. The UE obtains the cell assistance information (CAI) based on one or more of the following mechanisms: by receiving system information of the cell, based on historical data or statistics, based on pre-defined rule (e.g., type of satellite, satellite speed, UE location, time of the day etc.).

A first embodiment comprises a method in a UE of determining whether at least cells (e.g., Cell1 and Cell2) meet one or more measurement similarity condition(s) (MS condition(s)) and adapting one or more measurement procedures based on whether or not the one or more MS conditions is met. These two steps are described below:

The UE determines whether the at least 2 cells meet the MS conditions based on one or more pre-defined rules and/or by receiving information from a network node (e.g., from NW1 via signaling etc.). The UE determines that the at least 2 cells meet at one MS condition if they (cells) are similar; otherwise, they do not meet the MS conditions. The at least 2 cells are considered similar provided that one or more of the following criteria is met:
Cell1 and Cell2 are operated by a network node, which may be the same or different satellites.
Cell1 and Cell2 are operated by the same type of satellite e.g., by the LEO satellite.
Cell1 and Cell2 are operated by the same satellite
Cell1 and Cell2 are associated with the same cell ID e.g., PCI, CGI etc.
Cell1 and Cell2 operate on or belong to the same carrier frequency
The spatial distance between the satellite operating Cell 1 and the satellite operating Cell2 at T-service-start is closer than a threshold.
UE receives information sent by NW1 directly indicating Cell1 and Cell2 meeting MS condition.

The UE may further obtain information about at least one cell (e.g., Cell2) if they do not meet the MS condition. The UE may obtain the information based on a pre-defined rule or by receiving the information from a network node (e.g., from SI sent by NW1). The information may comprise one or more of the following: cell ID of Cell2, carrier frequency of Cell2, indication about type of cell (e.g., whether operated by TN, NTN or ATG node etc.) etc.

Particularly, Cell2 starts service from T-service-start broadcasted by current serving cell (Cell1) which expires after T-service typically.
In one example of the first embodiment, Cell1 and Cell2 meet MS condition provided Cell2 which starts service from T-service-start is the same cell as the current serving cell (Cell1). Otherwise, they don't meet MS condition provided Cell2 which starts service from T-service-start isn't same cell as the current serving cell (Cell1).

The UE adaptively adjusts, updates or changes one or more operational behaviors or procedures with respect to one or more MS condition(s) met or not according to one or more rules. The UE further meets corresponding requirements associated with the adaptive one or more operational behaviors or procedures. Examples of such rules are:
In one example, if Cell1 and Cell2 meet at least one MS condition then the UE starts searching the cells starting from time instance from Tservice-start+M1. In this case the UE may also identify at least one cell (e.g., Cell2) within Tsearch starting from Tservice-start+M1. Where M1 is a margin. In one example, M1=0.
In another example, if Cell1 and Cell2 do not meet any MS condition then the UE starts searching the cells starting from time instance Tservice-start+M2. In this case the UE may also identify at least one cell (e.g., Cell2) within Tsearch-start+Tsi+M3 starting from Tservice-start+M2. Where M2 is a margin, M3 is margin to account for differences between Cell1 and Cell2 and Tsi is time to acquire SI of Cell2. In one example, M2=0 and M3=0.

A second embodiment comprises a method in a first network node (NW1) of determining whether at least two cells (e.g., Cell1 and Cell2) meet one or more MS conditions and transmitting the determined information to a UE. NW1 may further transmit information about cell2 to the UE e.g., cell ID of Cell2, carrier frequency of Cell2, indication about type of cell (e.g., whether operated by TN, NTN or ATG node etc.) etc. Alternatively, NW1 may transmit the message related to Cell1 and Cell2 meeting MS condition or not meeting MS condition to the UE.

The suggested solution(s) provide mechanism for a UE in one or more network nodes, e.g., NTN, IoT NTN, NT or ATG network node, to adaptively adjust operational behaviors or procedures, including paging reception and measurement procedures and based on time assistance information.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows an example architecture of a satellite network with bent pipe transponders (i.e., the transparent payload architecture);

FIG. 2 illustrates that a satellite orbit can be fully described using 6 parameters;

FIG. 3 provides an illustration of SSB, SMTC window, and measurement gap;

FIG. 4 illustrates that a ATG BS is much more powerful than the legacy terrestrial BS since its coverage range could increase up to 200 km as compared with cell coverage up to hundreds of meters of the legacy terrestrial BS, according to some embodiments of the present disclosure;

FIG. 5 illustrates one example of a cellular communications system in which embodiments of the present disclosure may be implemented;

FIG. 6 illustrates such a scenario as a function of time. UE at T₀ is camping on a quasi-Earth fixed NTN cell named “Cell A” and served by satellite Sat_{N}, according to some embodiments of the present disclosure;

FIG. 7 is a schematic block diagram of a radio access node according to some embodiments of the present disclosure;

FIG. 8 is a schematic block diagram that illustrates a virtualized embodiment of the radio access node according to some embodiments of the present disclosure;

FIG. 9 is a schematic block diagram of the radio access node according to some other embodiments of the present disclosure;

FIG. 10 is a schematic block diagram of a wireless communication device according to some embodiments of the present disclosure;

FIG. 11 is a schematic block diagram of the wireless communication device according to some other embodiments of the present disclosure;

FIG. 12 illustrates a communication system includes a telecommunication network, such as a 3GPP-type cellular network, which comprises an access network, such as a RAN, and a core network, according to some other embodiments of the present disclosure;

FIG. 13 illustrates a communication system with a host computer that comprises hardware including a communication interface configured to set up and maintain a wired or wireless connection with an interface of a different communication device of the communication system, according to some other embodiments of the present disclosure;

FIG. 14 is a flowchart illustrating a method implemented in a communication system, in accordance with one embodiment;

FIG. 15 is a flowchart illustrating a method implemented in a communication system, in accordance with one embodiment;

FIG. 16 is a flowchart illustrating a method implemented in a communication system, in accordance with one embodiment; and

FIG. 17 is a flowchart illustrating a method implemented in a communication system, in accordance with one embodiment.

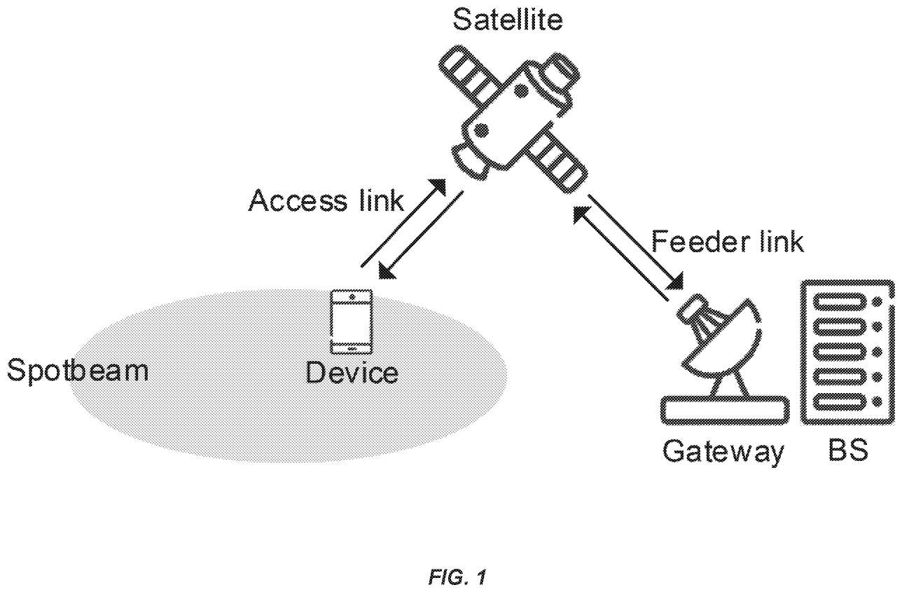

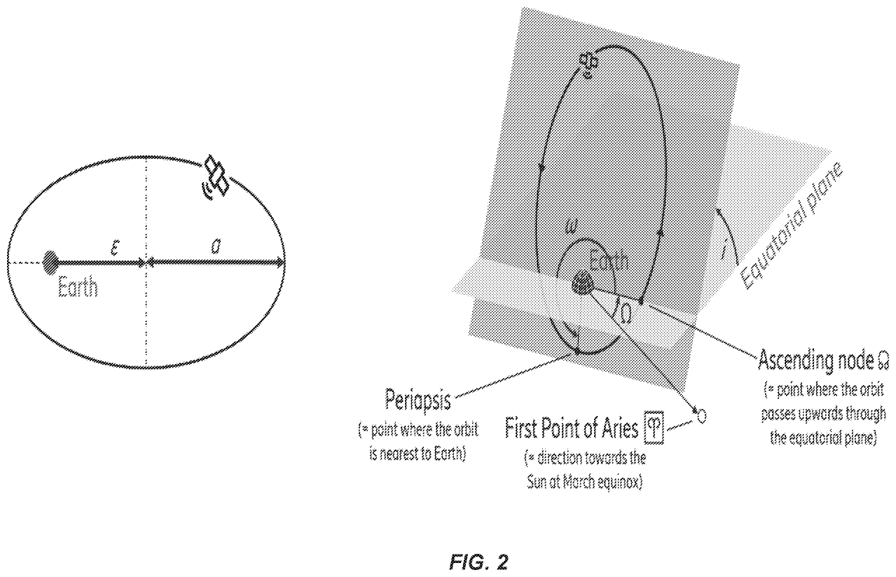

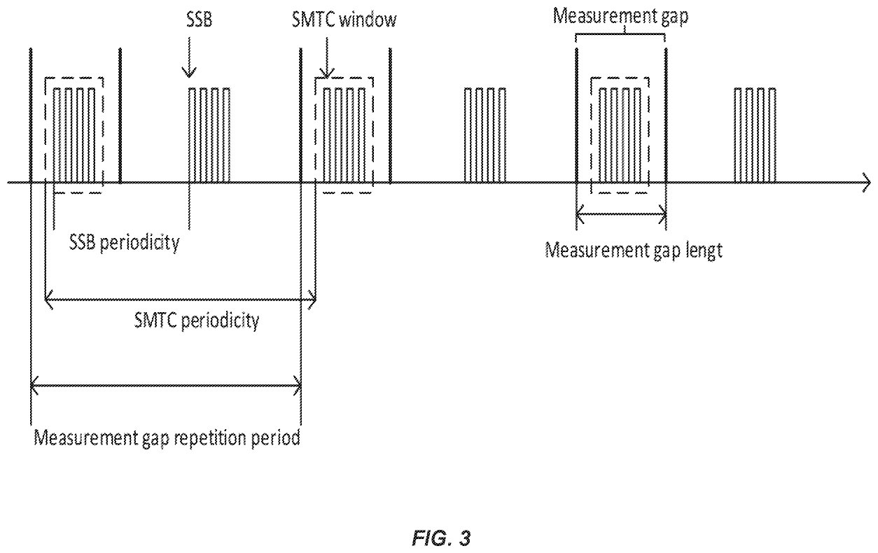

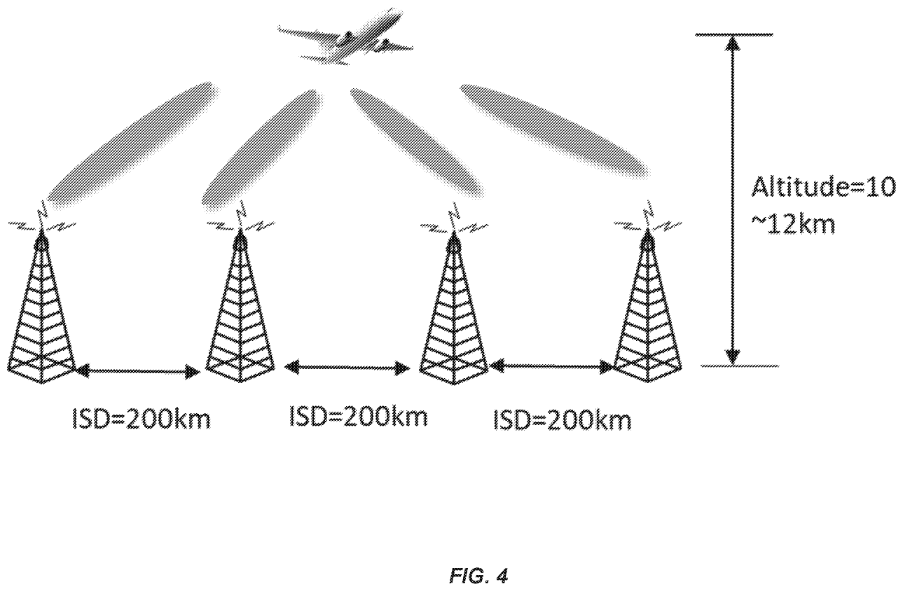

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may be a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

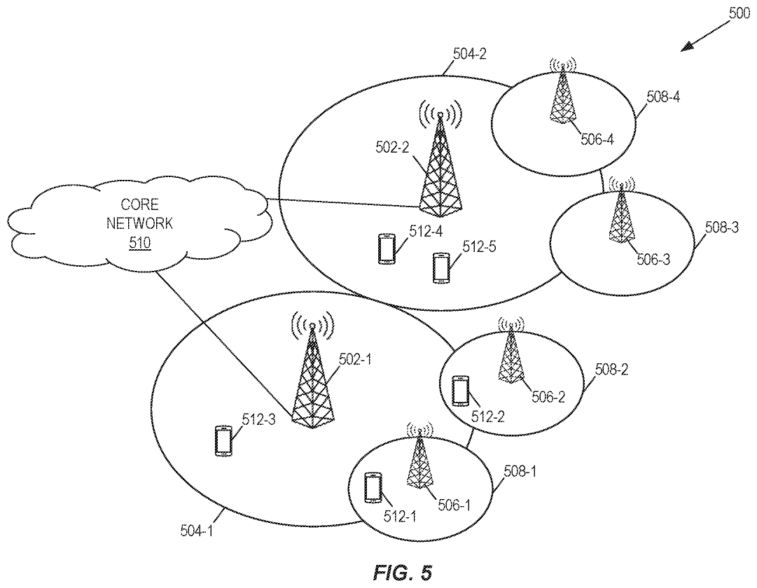

FIG. 5 illustrates one example of a cellular communications system 500 in which embodiments of the present disclosure may be implemented. In the embodiments described herein, the cellular communications system 500 is a 5G system (5GS) including a Next Generation RAN (NG-RAN) and a 5G Core (5GC). In this example, the RAN includes base stations 502-1 and 502-2, which in the 5GS include NR base stations (gNBs) and optionally next generation eNBs (ng-eNBs) (e.g., LTE RAN nodes connected to the 5GC), controlling corresponding (macro) cells 504-1 and 504-2. The base stations 502-1 and 502-2 are generally referred to herein collectively as base stations 502 and individually as base station 502. Likewise, the (macro) cells 504-1 and 504-2 are generally referred to herein collectively as (macro) cells 504 and individually as (macro) cell 504. The RAN may also include a number of low power nodes 506-1 through 506-4 controlling corresponding small cells 508-1 through 508-4. The low power nodes 506-1 through 506-4 can be small base stations (such as pico or femto base stations) or RRHs, or the like. Notably, while not illustrated, one or more of the small cells 508-1 through 508-4 may alternatively be provided by the base stations 502. The low power nodes 506-1 through 506-4 are generally referred to herein collectively as low power nodes 506 and individually as low power node 506. Likewise, the small cells 508-1 through 508-4 are generally referred to herein collectively as small cells 508 and individually as small cell 508. The cellular communications system 500 also includes a core network 510, which in the 5G System (5GS) is referred to as the 5GC. The base stations 502 (and optionally the low power nodes 506) are connected to the core network 510.

The base stations 502 and the low power nodes 506 provide service to wireless communication devices 512-1 through 512-5 in the corresponding cells 504 and 508. The wireless communication devices 512-1 through 512-5 are generally referred to herein collectively as wireless communication devices 512 and individually as wireless communication device 512. In the following description, the wireless communication devices 512 are oftentimes UEs, but the present disclosure is not limited thereto.

### Terminology

In this disclosure, the term “satellite” is often used even when a more appropriate term would be “gNB associated with the satellite”. The term “satellite” may also be called as a satellite node, a NTN node, node in the space etc. Here, gNB associated with a satellite might include both a regenerative satellite, where the gNB is the satellite payload, i.e., the gNB is integrated with the satellite, or a transparent satellite, where the satellite payload is a relay and gNB is on the ground (i.e., the satellite relays the communication between the gNB on the ground and the UE).

Time period or duration over which a UE can maintain connection, or can camp on, or can maintain communication, and so on to a satellite or a gNB by UE is referred to as term “coverage time” or “serving time” or “network availability” or “sojourn time” or “dwell time” etc. The term ‘Non-coverage time’, also known as “non-serving time” or “network unavailability”, or “non-sojourn time”, or “non-dwell time”, or “coverage gap” refers to a period of time during which a satellite or gNB cannot serve or communicate or provide coverage to a UE. Another way to interpret the availability is that is not about a satellite/network strictly not able to serve the UE due to lack of coverage but that UE does not need to measure certain “not likely to be serving cell (satellite via which serving cell is broadcasted)”. In this case, the terminology may still be as in no coverage case or it may be different, e.g., “no need to measure”.

The terms “serving time”, “remaining serving time”, “remaining service time”, and “remaining time to serve” all refer to the remaining time a cell will keep providing coverage in a certain area. In 3GPP documents, it is also referred to as “Tservice”, “tservice”, “t-Service” or “t-Service-r17” and is broadcast in System Information. An alternative indication of when the cell will stop serving the area is the “serving cell stop time”, which is also a term that may be used in the solution description. This concept is applicable (mainly) for quasi-earth-fixed cells, which is also the deployment scenario the proposed solution mainly targets. For a quasi-earth-fixed cell, the concept may also be formulated as the time remaining until the cell disappears.

The term node is used which can be a network node or a user equipment (UE). Examples of network nodes are NodeB, base station (BS), multi-standard radio (MSR) radio node such as MSR BS, eNodeB, gNodeB, MeNB, SeNB, location measurement unit (LMU), integrated access backhaul (IAB) node, network controller, radio network controller (RNC), base station controller (BCS), relay, donor node controlling relay, base transceiver station (BTS), Central Unit (e.g., in a gNB), Distributed Unit (e.g., in a gNB), Baseband Unit, Centralized Baseband, C-RAN, access point (AP), transmission points, transmission nodes, transmission reception point (TRP), RRU, RRH, nodes in distributed antenna system (DAS), core network node (e.g., MCS, MME etc.), O&M, OSS, SON, positioning node (e.g., E-SMLC), etc.

The non-limiting term UE refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, PDA, tablet, mobile terminals, smart phone, laptop embedded equipment (LEE), laptop mounted equipment (LME), USB dongles etc.

The term radio access technology, or RAT, may refer to any RAT e.g., UTRA, E-UTRA, narrow band internet of things (NB-IoT), WiFi, Bluetooth, next generation RAT, New Radio (NR), 4G, 5G, NR NTN, IoT NTN, LTE NTN, etc. Any of the equipment denoted by the term node, network node or radio network node may be capable of supporting a single or multiple RATs.

The term signal or radio signal used herein can be any physical signal or physical channel. Examples of DL physical signals are reference signal (RS) such as PSS, SSS, CSI-RS, DMRS signals in SS/PBCH block (SSB), discovery reference signal (DRS), CRS, PRS etc. RS may be periodic e.g., RS occasion carrying one or more RSs may occur with certain periodicity e.g., 20 ms, 40 ms etc. The RS may also be aperiodic. Each SSB carries NR-PSS, NR-SSS and NR-PBCH in 4 successive symbols. One or multiple SSBs are transmitted in one SSB burst which is repeated with certain periodicity e.g., 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprises parameters such as SMTC periodicity, SMTC occasion length in time or duration, SMTC time offset with regard to reference time (e.g., serving cell's SFN) etc. Therefore, SMTC occasion may also occur with certain periodicity e.g., 5 ms, 10 ms, 20 ms, 40 ms, 80 ms and 160 ms. Examples of UL physical signals are reference signals such as SRS, DMRS etc. The term physical channel refers to any channel carrying higher layer information e.g., data, control, etc. Examples of physical channels are PBCH, NPBCH, PDCCH, PDCSH, sPUCCH, sPDCSH, sPUCCH, sPUCSH, MPDCCH, NPDCCH, NPDCSH, E-PDCCH, PUCSH, PUCCH, NPUCSH etc.

There currently exist certain challenges. Discontinuous satellite coverage, where the visibility of a satellite or group of satellites, commonly Low Earth Orbit (LEO), is prevalent for serving IoT devices. However, in Rel-17, the mechanism for discontinuous satellite coverage is overly simplified. For example, the current serving cell only informs the UE when in time (T-service-start) the new satellite will provide/resume the coverage. Due to this limited information the UE measurement related procedures are not well defined. For example, it is undefined when exactly in time the UE can start measurements on the cell served or managed by the new satellite coverage. The UE can only receive paging in the cell after it has acquired the synchronization which requires measurements on that cell. Therefore, due to lack of the well-defined UE measurement behavior there is uncertainty about the time from when onwards the UE is able to receive paging or other DL channels and/or from when onwards the UE can resume any uplink transmission in the cell after the discontinuous coverage. This leads to loss of paging and may also miss or delay in starting the UE originating sessions. Therefore, a new mechanism is needed to ensure that the UE operational behavior (e.g., measurements, paging reception etc.) after the discontinuous coverage is well defined. This in turn should also allow the UE to resume operation after the discontinuous service with no or minimum possible delay.

Certain aspects of the present disclosure and their embodiments may provide solutions to the aforementioned or other challenges. The proposed solution(s) is set(s) of mechanisms for a UE in a first cell (Cell1) served or managed by a first network node (NW1) and a second cell (Cell2) served or managed by a second network node (NW2). The UE is served by Cell1 and Cell2 at different times. Cell1 stops serving the area or zone where the UE is located at a time instance, T-service. Cell2 starts serving the area or zone where the UE is located from time instance, T-service-start.

The network nodes, NW1 or NW2 therein could belong to any type of network among NTN (IoT NTN or NR NTN) network (e.g., UE served by IoT NTN or NR NTN node), TN network or ATG network. The UE obtains the cell assistance information (CAI) based on one or more of the following mechanisms: by receiving system information of the cell, based on historical data or statistics, based on pre-defined rule (e.g., type of satellite, satellite speed, UE location, time of the day etc.).

A first embodiment comprises a method in a UE of determining whether at least cells (e.g., Cell1 and Cell2) meet one or more measurement similarity condition(s) (MS condition(s)) and adapting one or more measurement procedures based on whether or not the one or more MS conditions is met. These two steps are described below:

The UE determines whether the at least 2 cells meet the MS conditions based on one or more pre-defined rules and/or by receiving information from a network node (e.g., from NW1 via signaling etc.). The UE determines that the at least 2 cells meet at one MS condition if they (cells) are similar; otherwise, they do not meet the MS conditions. The at least 2 cells are considered similar provided that one or more of the following criteria is met:
Cell1 and Cell2 are operated by a network node, which may be the same or different satellites.
Cell1 and Cell2 are operated by the same type of satellite e.g., by the LEO satellite.
Cell1 and Cell2 are operated by the same satellite
Cell1 and Cell2 are associated with the same cell ID e.g., PCI, CGI etc.
Cell1 and Cell2 operate on or belong to the same carrier frequency.
The spatial distance between the satellite operating Cell 1 and the satellite operating Cell2 at T-service-start is closer than a threshold.
UE receives information sent by NW1 directly indicating Cell1 and Cell2 meeting MS condition.

The UE may further obtain information about at least one cell (e.g., Cell2) if they do not meet the MS condition. The UE may obtain the information based on a pre-defined rule or by receiving the information from a network node (e.g., from SI sent by NW1). The information may comprise one or more of the following: cell ID of Cell2, carrier frequency of Cell2, indication about type of cell (e.g., whether operated by TN, NTN or ATG node etc.) etc.

Particularly, Cell2 starts service from T-service-start broadcasted by current serving cell (Cell1) which expires after T-service typically.
In one example of the first embodiment, Cell1 and Cell2 meet MS condition provided Cell2 which starts service from T-service-start is the same cell as the current serving cell (Cell1). Otherwise, they don't meet MS condition provided Cell2 which starts service from T-service-start isn't same cell as the current serving cell (Cell1).

The UE adaptively adjusts, updates, or changes one or more of operational behaviors or procedures with respect to one or more MS condition(s) met or not according to one or more rules. The UE further meets corresponding requirements associated with the adaptive one or more operational behaviors or procedures. Examples of such rules are:
In one example, if Cell1 and Cell2 meet at least one MS condition then the UE starts searching the cells starting from time instance from Tservice-start+M1. In this case the UE may also identify at least one cell (e.g., Cell2) within Tsearch starting from Tservice-start+M1. Where M1 is a margin. In one example, M1=0.
In another example, if Cell1 and Cell2 do not meet any MS condition then the UE starts searching the cells starting from time instance Tservice-start+M2. In this case the UE may also identify at least one cell (e.g., Cell2) within Tsearch-start+Tsi+M3 starting from Tservice-start+M2. Where M2 is a margin, M3 is margin to account for differences between Cell1 and Cell2 and Tsi is time to acquire SI of Cell2. In one example, M2=0 and M3=0.

A second embodiment comprises a method in a first network node (NW1) of determining whether at least two cells (e.g., Cell1 and Cell2) meet one or more MS conditions and transmitting the determined information to a UE. NW1 may further transmit information about cell2 to the UE e.g., cell ID of Cell2, carrier frequency of Cell2, indication about type of cell (e.g., whether operated by TN, NTN or ATG node etc.) etc. Alternatively, NW1 may transmit the message related to Cell1 and Cell2 meeting MS condition or not meeting MS condition to the UE.

The suggested solution(s) provide mechanism for a UE in one or more network nodes, e.g., NTN, IoT NTN, NT or ATG network node, to adaptively adjust operational behaviors or procedures, including paging reception and measurement procedures and based on time assistance information.

There are, proposed herein, various embodiments which address one or more of the issues disclosed herein.

Certain embodiments may provide one or more of the following technical advantages. The method enables smooth transition of the ongoing communication/session across cells served or managed by satellites in discontinuous coverage scenario. The UE measurement behavior is well defined when the UE resumes/re-establishes the communication link upon resumption of the satellite coverage. The methods enable the UE power saving as it searches only the cells which are likely available at the UE location upon resumption of the satellite coverage. The method avoids or minimizes the loss of paging reception upon resumption of the satellite coverage.

Systems and methods for assisted measurement procedure under NTN discontinuous coverage are provided. In some embodiments, a method performed by a UE for adapting one or more measurement procedures includes: determining whether at least two cells of a plurality of cells meet one or more Measurement Similarity (MS) conditions based on Cell Assistance Information (CAI). In response to determining the at least two cells of a plurality of cells meet one or more MS conditions, the UE adapts one or more measurement procedures. This might enable smooth transition of the ongoing communication/session across cells served or managed by satellites in discontinuous coverage scenario. The UE measurement behavior is well defined when the UE resumes/re-establishes the communication link upon resumption of the satellite coverage. This enables UE power saving as it searches only the cells which are likely available at the UE location upon resumption of the satellite coverage. This avoids or minimizes the loss of paging reception upon resumption of the satellite coverage.

### Description of Scenario

The scenario comprises a UE in a first cell (Cell1) served or managed or operated by a first network node (NW1) and in a second cell (Cell2) served or managed or operated by a first network node (NW2). NW1 and NW2 are examples of TN, NTN, IoT NTN or ATG node in this disclosure. Examples of the IoT NTN node are satellite node, high altitude platform BS (HAPS), drone base station, etc. Satellite node is also called herein as satellite access node (SAN). An example of NW1 is a first SAN (SAN1), which manages or serves or operates or controls cell1. An example of NW2 is a second SAN (SAN2), which manages or serves or operates or controls cell2.

Cell2 starts to serve the UE from a time instance, Tservice-start. Cell1 is the last or previous serving cell (i.e., before served by Cell2) of the UE which expired from T-service and before Tservice-start. The UE cannot be served by a cell, which has expired. The UE obtains information about Tservice-start by acquiring the system information (SI) (e.g., SIB) of Cell1 or derives information about Tservice-start from ephemeris data of Cell2 (e.g., ‘tle-EphemerisParameters’ in TS36.331 V17.1.0) provided by the previous or one of the previous serving cells e.g., by Cell1.

The term serving an area may refer to operation of signals (e.g., reference signals, system information, paging, data, random access, etc.) between the serving cell and the UE served by that serving cell.

It is worth noting that Tservice-start indicates or implies starting time for the incoming cell, i.e., Cell2 to serve an area or region, the definition of the cell may follow one of the following rules:
In one example, Cell2 is the first cell or one of first cells to start serving upon or after T-service-start.
In another example, Cell2 is a cell determined by NW1 to start serving upon or after T-service-start.
In another example, Cell2 is a cell or one of cells searched and/or determined by UE to start serving upon or after T-service-start.
In another example, Cell2 is the first cell or one of first cells meeting one or more conditions (e.g., type of satellite operated by Cell2, carrier frequency and etc.) to start serving upon or after T-service-start.

The embodiments described herein may also be implemented in any combination. The UE embodiment comprises at least the following steps:
Step 1: The UE identifies measurement similarity (MS) condition(s) associated with at least two cells.
Step 2: After or upon resuming the satellite coverage (e.g., from time instance Tservice-start), the UE adapts one or more operational behaviors or procedures with respect to or based on whether MS condition(s) is met or not for the at least 2 cells.

Prior to the adaptation, the UE determines the one or more operational behaviors or procedures.

The UE may further fulfill the corresponding applicable requirements associated with the adapted one or more operational behaviors or procedures used based on whether meeting MS condition(s) is or not for the at least 2 cells.

These steps are described in detail in the sections below.

### Measurement Similarity (MS) Condition(s):

The UE determines whether two or more cells, e.g., Cell1 and Cell2, meet the MS conditions based on one or more pre-defined rules and/or by receiving information from a network node (e.g., from NW1 via signaling and etc.).

The UE determines that the at least 2 cells meet at one MS condition if they (cells) are similar; otherwise, they do not meet the MS conditions. The at least 2 cells are considered similar provided that one or more of the following criteria is met, taking Cell1 and Cell 2 as example:
Cell1 and Cell2 are operated by a network node, which may be the same or different satellites.
Cell1 and Cell2 are operated by the same type of satellite e.g., by the LEO satellite.
Cell1 and Cell2 are operated by different satellites with similar trajectory, i.e., they belong to the same orbital plane, and may have similar height and speed.
Cell1 and Cell2 are operated by the same satellite.
Cell1 and Cell2 are associated with the same cell ID e.g., PCI, CGI etc.
Cell1 and Cell2 are associated with the same tracking area given by its TAC or TAI.
Cell1 and Cell2 operate on or belong to the same carrier frequency
The spatial distance between the satellite operating Cell 1 and the satellite operating Cell2 at T-service-start are closer/below than a threshold.
UE receives dedicated information or message sent by NW1 directly indicating Cell1 and Cell2 meeting MS condition through RRC signaling TCI or MAC-CE command.
The time interval between T-service and T-service-start, i.e., (T-service-start-T-service) is shorter than a threshold.

In addition to information related to whether MS condition is met, the information provided the by network node (e.g., NW1 or NW2) may also indicate the type of cell, e.g., whether the cell2 and cell1 are of same type or different type. In one example, the MS condition may still be met even though the cells may belong to different types. Examples of types of cells are NTN cell, ATG cell, terrestrial cell, etc. In one specific example, the information may comprise of one 1 bit indicate indicating whether cell1 and cell2 are of same type. In another specific example, the information may explicitly indicate the type of cell. In one example, cell1 and cell2 are NTN and ATG cells respectively. In another example, cell1 and cell2 are ATG and NTN cell respectively.

The UE shall be able to assess the criteria of MS conditions with respect to available information, e.g., based on set(s) of cell assistance information (CAI). The UE obtains the cell assistance information (CAI) based on one or more of the following mechanisms: by receiving system information of the serving cell, by dedicated RRC signaling with the methods described in P105064, based on historical data or statistics, based on assistance information provided by the network via user plane, based on pre-defined rule (e.g., type of satellite, satellite speed, UE location, time of the day and etc.).

The serving cell (Cell1) ceases to provide service to an area where a UE is located after T-service due to the movement of the satellite. For a quasi-earth fix cell, Cell2 starts service from T-service-start which is given in System Information. For an Earth moving cell, a UE may calculate Cell2's approximate T-service-start from the assistance information provided in System Information (e.g., tle-EphemerisParameters-r17, footprintInfo-r17). Thus, UE is aware of stop and start serving values from the broadcast in System Information by current serving cell (Cell1) or previous serving cells, or from dedicated RRC signaling.

In one example, Cell1 and Cell2 meet MS condition provided Cell2 which starts service from T-service-start is the same cell as the current serving cell (Cell1), i.e., both cells broadcast the same cell ID value.

In another example, Cell1 and Cell2 don't meet MS condition provided Cell2 which starts service from T-service-start isn't same cell as the current serving cell (Cell1).

In one example, Cell1 and Cell2 meet MS condition provided Cell2 belongs to the same tracking area as the current serving cell (Cell1), i.e., both cells broadcast the same TAC or TAI value.

In another example, Cell1 and Cell2 don't meet MS condition provided do not belong to the same tracking area as the current serving cell (Cell1).

In another example, Cell1 and Cell2 meet MS condition provided Cell2 which starts service from T-service-start is operated by the same satellite as the satellite operating the current serving cell (Cell1). The UE may assess this condition by comparing the satellite's ID value (satelliteId-r17) broadcast in System Information.

In another example, Cell1 and Cell2 don't meet MS condition provided Cell2 which starts service from T-service-start isn't operated by the same satellite as the satellite operating the current serving cell (Cell1).

In another example, Cell1 and Cell2 meet MS condition provided Cell2 use the same carrier frequency. The UE may assess this condition by comparing the value carried on the IE ARFCN-ValueEUTRA.

In another example, Cell1 and Cell2 meet MS condition provided UE receives short message by NW1 to indicate MS condition validity between Cell1 and Cell2.

In another example, Cell1 and Cell2 don't meet MS condition provided UE doesn't receive short message by NW1 to indicate MS condition validity between Cell1 and Cell2.

The UE may further obtain information about at least one cell (e.g., Cell2) if they do not meet the MS condition. The UE may obtain the information based on a pre-defined rule or by receiving the information from a network node (e.g., from SI sent by NW1). The UE may also actively request the information from a network node. The information may comprise one or more of the following: cell ID of Cell2, carrier frequency of Cell2, indication about type of cell (e.g., whether operated by TN, NTN or ATG node, etc.), etc.

To facilitate a UE to assess MS condition(s), a first network node (NW1) serving the UE through Cell1 shall determine whether at least cells (e.g., Cell1 and Cell2) meet one or more MS condition and transmitting the determined information to the UE.

In one example, NW1 may further transmit information about Cell2 to the UE e.g., cell ID of Cell2, carrier frequency of Cell2, indication about type of cell (e.g., whether operated by TN, NTN or ATG node etc.), etc. by System Information broadcast, Short Messages, dedicated RRC signaling, DCI or MAC-CE signaling.

In another example, NW1 may transmit the message of Cell1 and Cell 2 indicating meeting MS condition or not meeting MS condition to UE, the message may be RRC, DCI or MAC-CE signaling.

The information provided by a network node may not be limited to the next incoming cell, i.e., the very next cell that takes over the area after the serving cell ceases to provide coverage. In the example above, Cell2 is the very next cell that comes after Cell1 stops serving. The network node might provide the UE with a list of size N, where each entry in the list corresponds to information about an incoming cell, the list is ordered sequentially as a function of start time of service (T-service-start) and is specific to the area where the UE is presently located. The list size N may be limited by the accuracy of ephemerides calculations, i.e., how accurately a network node may predict a satellite's future movements.

Operational Behaviors/Procedures with Respect to One or More MS Condition(s)

The UE adaptively adjusts, updates or changes one or more of operational behaviors or procedures with respect to one or more MS condition(s) met or not according to one or more rules. The UE further meets corresponding requirements associated with the adaptive one or more operational behaviors or procedures. The forementioned operational behaviors or procedures may comprise one or more of the following examples:
Measurement procedures (e.g., start time to measure, measurement time (e.g., cell search delay, measurement period of a measurement etc.), measurement or sampling rate, periodicity, duration, total number of carriers/frequencies/cells/satellites to be measured, etc.)
Radio link operations (RLO) (e.g., radio link monitoring: radio link failure/problem, RRC-establishment, etc., link recovery procedure: beam failure detection, candidate beam detection, candidate beam recovery, beam failure recovery, etc.)
Cell changes (e.g., handover, conditional cell change, conditional handover (CHO), cell reselection, cell selection, RRC release with redirection, RRC connection re-establishment, etc.)
Channel monitoring or reception procedure (e.g., paging reception, system information reception (e.g., MIB, SIB1 or other SIBs, etc.)
GNSS acquisition (receive and validate GNSS signals)

Examples of such rules to adjust operational behaviors based on MS condition(s) are:

### Start Time to Search a Cell:

In one example, if Cell1 and Cell2 meet at least one MS condition then the UE starts searching, synchronizing and measuring the cells starting from time instance from Tservice-start+M1. In this case the UE may also identify at least one cell (e.g., Cell2) within Tsearch starting from Tservice-start+M1. Where M1 is a margin.
   In one example M1=0, in another example M1=plurality of SSB/SMTC/DRX periodicity, in another example M1 is a predefined time period.
   In another example, if Cell1 and Cell2 meet at least one MS condition then the UE isn't required to do one or more than one operation, e.g., searching, synchronizing and measuring the cells.
In another example, if Cell1 and Cell2 do not meet any MS condition then the UE starts searching, synchronizing and measuring the cells starting from time instance Tservice-start+M2. In this case the UE may also identify at least one cell (e.g., Cell2) within Tsearch-start+Tsi+M3 starting from Tservice-start+M2. Where M2 is a margin, M3 is margin to account for differences between Cell1 and Cell2, wherein, Tsi is time to acquire necessary system information of Cell2.
   In one example M2=0 and M3=0, in another example, M2+M3. In another example M2 or M3=plurality of SSB/SMTC/DRX periodicity, in another example M2 or M3 is a predefined time period.
In another example, if Cell1 and Cell2 meet at least one MS condition then the UE may also identify at least one cell (e.g., Cell2) within Tsearch starting from Tservice-start+Tsi1+M10; if Cell1 and Cell2 do not meet any MS condition then the UE may also identify at least one cell (e.g., Cell2) within Tsearch starting from Tservice-start+Tsi2+M3. Wherein, Tsi1 and Tsi2 are time to acquire different set(s) of system information of Cell2 and Tsi1≠Tsi2, in one example, Tsi1<Tsi2.

### Known/Unknown Cell:

In another example, if Cell1 and Cell2 meet any MS condition then the UE uses or relies on or applies network configurations associated with Cell1. In other words, Cell2 is known to the UE due to similarity to Cell1, when UE is entering Cell2's coverage after leaving Cell1's coverage.
In another example, if Cell1 and Cell2 do not meet any MS condition then the UE does not use or rely on or apply network configurations associated with Cell1. In other words, Cell2 is unknown to the UE and is this case the UE shall acquire network configurations through cell search (e.g., SSB measurement), SI reading, RRC signaling reading etc., when UE is entering Cell2's coverage after leaving Cell1's coverage.

### Paging Reception:

In another example, if Cell1 and Cell2 meet any MS condition then the UE shall be able to start monitoring downlink channels of Cell2 for paging reception starting from time instance Tservice-start+M4.
In another example, if Cell1 and Cell2 don't meet any MS condition, then the UE shall be able to start monitoring downlink channels of Cell2 for paging reception starting from time instance Tservice-start+Tsi+M5.
   In one example M4 or M5 herein is plurality of SSB/SMTC/DRX periodicity, in another example M4 or M5 is a predefined time period. Particularly, M4≠M5. In one example M4<M5, in another example M4=0 and M5=N*SMTC periodicity, where N is number, 1, 2, 3, or etc.
In another example, if Cell1 and Cell2 meet at least one MS condition then the UE shall be able to start monitoring downlink channels of Cell2 for paging reception starting from time instance Tservice-start+Tsi3+M11; if Cell1 and Cell2 do not meet any MS condition then the UE may also identify at least one cell (e.g., Cell2) within Tsearch starting from Tservice-start+Tsi4+M5. Wherein, Tsi3 and Tsi4 are time to acquire different set(s) of system information of Cell2 and Tsi3+Tsi4, in one example, Tsi3<Tsi4.

### GNSS:

In another example, if Cell1 and Cell2 don't meet any MS condition, then the UE shall acquire and validate GNSS before time instance Tservice-start+M6. In one example, M6=0. Subsequently, one or more than one procedure relying on GNSS validity shall in turn be applied after Tservice-start+M7, where M7 is a margin.
In another example, if Cell1 and Cell2 meet any MS condition, then the UE shall acquire and validate GNSS before time instance Tservice-start+M8. In one example, M8 is plurality of SSB/SMTC/DRX periodicity, in another example M8 is a predefined time period. Subsequently, one or more than one procedure relying on GNSS validity shall in turn be applied after Tservice-start+M9, where M9 is a margin.
   In one example, M6≠M8, in another example M4<M5. In another example M6 or M7=plurality of SSB/SMTC/DRX periodicity, in another example M2 or M3 is a predefined time period.

### Details on System Information Indication

As described earlier, MS indication can be broadcast in System Information or sent via a dedicated RRC message, MAC CE, or DCI. In the case of System Information, it can take several forms. In one embodiment, the new parameter is included in SystemInformationBlockType32(-NB) and is provided for each SatelliteInfo-r17 entry in the satelliteInfoList-r17. This new parameter can be a simple flag to indicate MS. In a separate embodiment, this flag can be associated with a PCI or carrier frequency or a list of those for a specific satellite. In another alternative, a PCI or carrier frequency or a list of those for a specific satellite are provided so that UE can autonomously assess MS by comparing values with its serving cell.

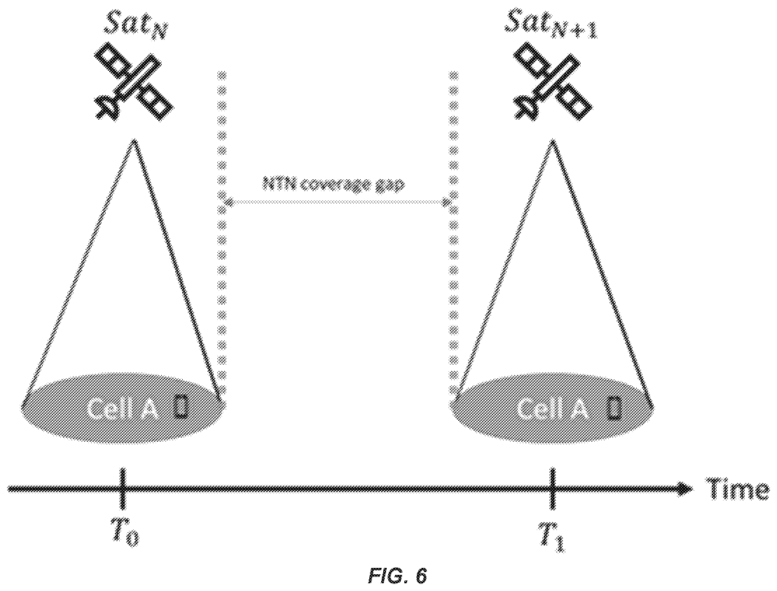

FIG. 6 illustrates such scenario as a function of time. UE at T₀ is camping on a quasi-Earth fixed NTN cell named “Cell A” and served by satellite Sat_{N}. This is followed by a period without NTN service (an NTN coverage gap) with a duration of T₁-T₀. There is a high probability that the same UE at T₁ camps on the same cell named “Cell A” (or a different one but with similar configuration) and now served by the next satellite Sat_{N+1}. Knowing this information (i.e., the relation between the cell before coverage gap and after coverage gap) is beneficial to the UE which can leverage the similarity between cells to accelerate measurements and re-gain uplink sync in a more efficient manner after a coverage gap.

In some embodiments, the UE will start cell selection procedure when back in NTN coverage upon reaching t-ServiceStart. In some embodiments, it is not the same as initial cell selection since this discontinuous coverage was expected based on the info provided in t-Service. Thus, depending on the time UE has been out of network coverage, the UE may need to regain the sync to be able to do the serving cell operation.

In some embodiments, the network should know that this UE is under discontinuous coverage and should not be paged during this time since this t-Service was already signaled to the UE. In some embodiments, the network knows UE is unreachable during the coverage gap. However, once the coverage gap is over, the network does not know how much time it takes for the UE to regain uplink sync. A UE in idle mode will not tell anything to the network unless it needs to do a Tracking Area Update.

In some embodiments, the problem is worse for Earth-moving cells. If a coverage gap ends at T, but the UE wrongly estimates the coverage gap ending at T+X, during time X, network may think UE is reachable when it is not.

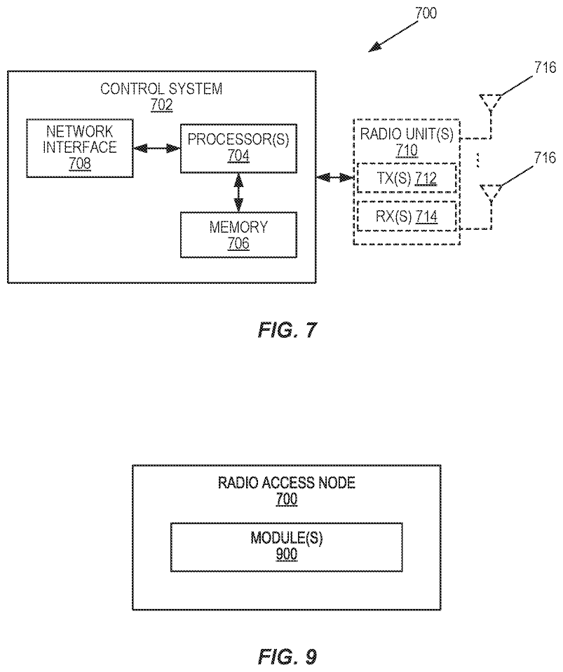

FIG. 7 is a schematic block diagram of a radio access node 700 according to some embodiments of the present disclosure. Optional features are represented by dashed boxes. The radio access node 700 may be, for example, a base station 502 or 506 or a network node that implements all or part of the functionality of the base station 502 or gNB described herein. As illustrated, the radio access node 700 includes a control system 702 that includes one or more processors 704 (e.g., Central Processing Units (CPUs), Application Specific Integrated Circuits (ASICs), Field Programmable Gate Arrays (FPGAs), and/or the like), memory 706, and a network interface 708. The one or more processors 704 are also referred to herein as processing circuitry. In addition, the radio access node 700 may include one or more radio units 710 that each includes one or more transmitters 712 and one or more receivers 714 coupled to one or more antennas 716. The radio units 710 may be referred to or be part of radio interface circuitry. In some embodiments, the radio unit(s) 710 is external to the control system 702 and connected to the control system 702 via, e.g., a wired connection (e.g., an optical cable). However, in some other embodiments, the radio unit(s) 710 and potentially the antenna(s) 716 are integrated together with the control system 702. The one or more processors 704 operate to provide one or more functions of a radio access node 700 as described herein. In some embodiments, the function(s) are implemented in software that is stored, e.g., in the memory 706 and executed by the one or more processors 704.

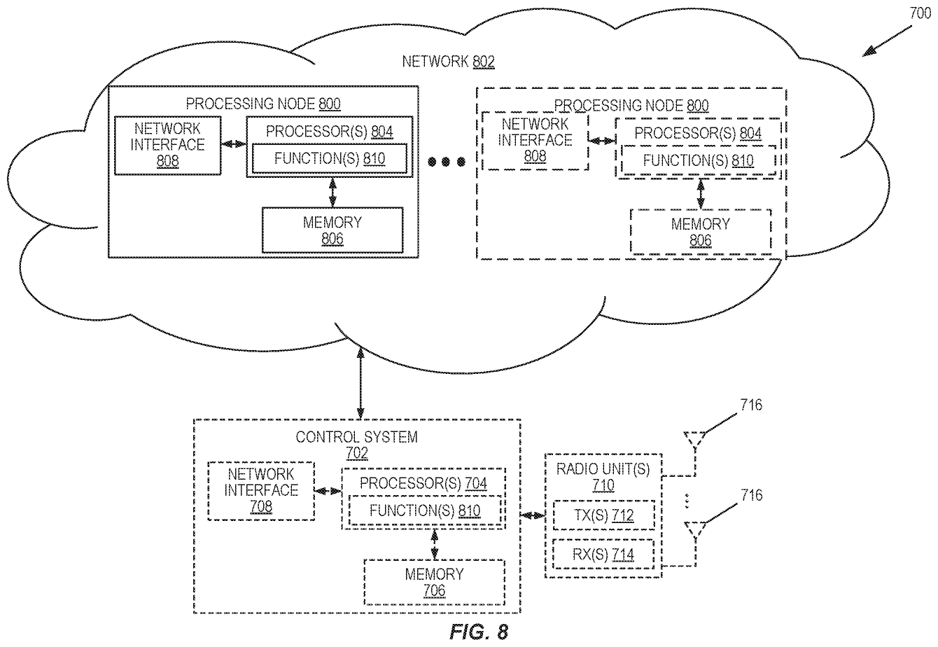

FIG. 8 is a schematic block diagram that illustrates a virtualized embodiment of the radio access node 700 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 700 in which at least a portion of the functionality of the radio access node 700 is implemented as a virtual component(s) (e.g., via a virtual machine(s) executing on a physical processing node(s) in a network(s)). As illustrated, in this example, the radio access node 700 may include the control system 702 and/or the one or more radio units 710, as described above. The control system 702 may be connected to the radio unit(s) 710 via, for example, an optical cable or the like. The radio access node 700 includes one or more processing nodes 800 coupled to or included as part of a network(s) 802. If present, the control system 702 or the radio unit(s) are connected to the processing node(s) 800 via the network 802. Each processing node 800 includes one or more processors 804 (e.g., CPUs, ASICs, FPGAs, and/or the like), memory 806, and a network interface 808.

In this example, functions 810 of the radio access node 700 described herein are implemented at the one or more processing nodes 800 or distributed across the one or more processing nodes 800 and the control system 702 and/or the radio unit(s) 710 in any desired manner. In some particular embodiments, some or all of the functions 810 of the radio access node 700 described herein are implemented as virtual components executed by one or more virtual machines implemented in a virtual environment(s) hosted by the processing node(s) 800. As will be appreciated by one of ordinary skill in the art, additional signaling or communication between the processing node(s) 800 and the control system 702 is used in order to carry out at least some of the desired functions 810. Notably, in some embodiments, the control system 702 may not be included, in which case the radio unit(s) 710 communicate directly with the processing node(s) 800 via an appropriate network interface(s).

In some embodiments, a computer program including instructions which, when executed by at least one processor, causes the at least one processor to carry out the functionality of radio access node 700 or a node (e.g., a processing node 800) implementing one or more of the functions 810 of the radio access node 700 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 9 is a schematic block diagram of the radio access node 700 according to some other embodiments of the present disclosure. The radio access node 700 includes one or more modules 900, each of which is implemented in software. The module(s) 900 provide the functionality of the radio access node 700 described herein. This discussion is equally applicable to the processing node 800 of FIG. 8 where the modules 900 may be implemented at one of the processing nodes 800 or distributed across multiple processing nodes 800 and/or distributed across the processing node(s) 800 and the control system 702.

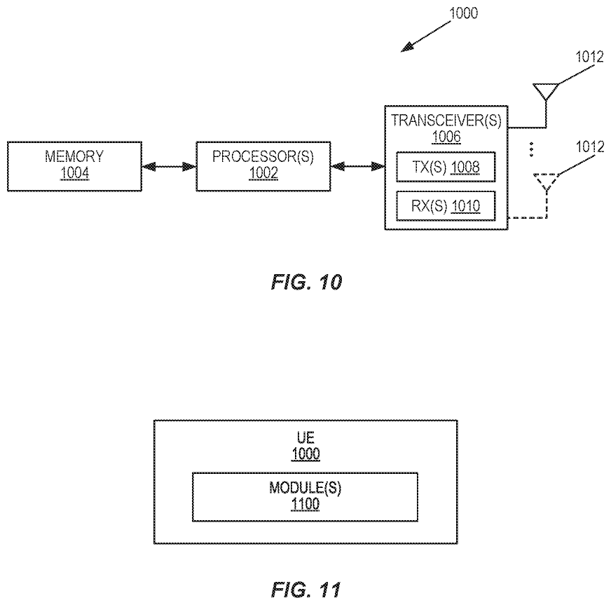

FIG. 10 is a schematic block diagram of a wireless communication device 1000 according to some embodiments of the present disclosure. As illustrated, the wireless communication device 1000 includes one or more processors 1002 (e.g., CPUs, ASICs, FPGAS, and/or the like), memory 1004, and one or more transceivers 1006 each including one or more transmitters 1008 and one or more receivers 1010 coupled to one or more antennas 1012. The transceiver(s) 1006 includes radio-front end circuitry connected to the antenna(s) 1012 that is configured to condition signals communicated between the antenna(s) 1012 and the processor(s) 1002, as will be appreciated by on of ordinary skill in the art. The processors 1002 are also referred to herein as processing circuitry. The transceivers 1006 are also referred to herein as radio circuitry. In some embodiments, the functionality of the wireless communication device 1000 described above may be fully or partially implemented in software that is, e.g., stored in the memory 1004 and executed by the processor(s) 1002. Note that the wireless communication device 1000 may include additional components not illustrated in FIG. 10 such as, e.g., one or more user interface components (e.g., an input/output interface including a display, buttons, a touch screen, a microphone, a speaker(s), and/or the like and/or any other components for allowing input of information into the wireless communication device 1000 and/or allowing output of information from the wireless communication device 1000), a power supply (e.g., a battery and associated power circuitry), etc.

In some embodiments, a computer program including instructions which, when executed by at least one processor, causes the at least one processor to carry out the functionality of the wireless communication device 1000 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the wireless communication device 1000 according to some other embodiments of the present disclosure. The wireless communication device 1000 includes one or more modules 1100, each of which is implemented in software. The module(s) 1100 provide the functionality of the wireless communication device 1000 described herein.

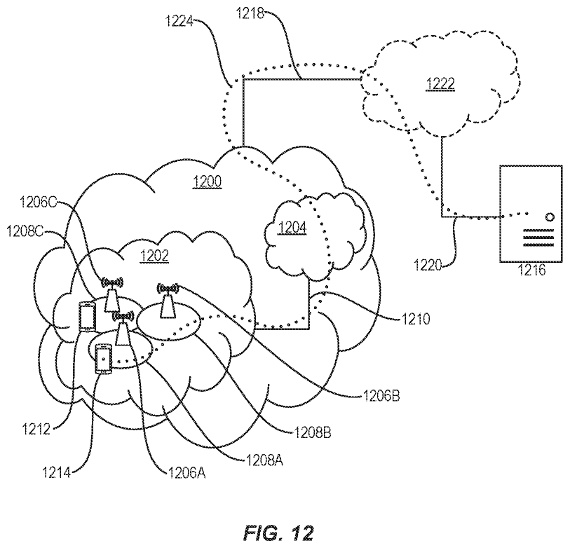

With reference to FIG. 12, in accordance with an embodiment, a communication system includes a telecommunication network 1200, such as a 3GPP-type cellular network, which comprises an access network 1202, such as a RAN, and a core network 1204. The access network 1202 comprises a plurality of base stations 1206A, 1206B, 1206C, such as Node Bs, eNBs, gNBs, or other types of wireless Access Points (APs), each defining a corresponding coverage area 1208A, 1208B, 1208C. Each base station 1206A, 1206B, 1206C is connectable to the core network 1204 over a wired or wireless connection 1210. A first UE 1212 located in coverage area 1208C is configured to wirelessly connect to, or be paged by, the corresponding base station 1206C. A second UE 1214 in coverage area 1208A is wirelessly connectable to the corresponding base station 1206A. While a plurality of UEs 1212, 1214 are illustrated in this example, the disclosed embodiments are equally applicable to a situation where a sole UE is in the coverage area or where a sole UE is connecting to the corresponding base station 1206.

The telecommunication network 1200 is itself connected to a host computer 1216, which may be embodied in the hardware and/or software of a standalone server, a cloud-implemented server, a distributed server, or as processing resources in a server farm. The host computer 1216 may be under the ownership or control of a service provider or may be operated by the service provider or on behalf of the service provider. Connections 1218 and 1220 between the telecommunication network 1200 and the host computer 1216 may extend directly from the core network 1204 to the host computer 1216 or may go via an optional intermediate network 1222. The intermediate network 1222 may be one of, or a combination of more than one of, a public, private, or hosted network; the intermediate network 1222, if any, may be a backbone network or the Internet; in particular, the intermediate network 1222 may comprise two or more sub-networks (not shown).

The communication system of FIG. 12 as a whole enables connectivity between the connected UEs 1212, 1214 and the host computer 1216. The connectivity may be described as an Over-the-Top (OTT) connection 1224. The host computer 1216 and the connected UEs 1212, 1214 are configured to communicate data and/or signaling via the OTT connection 1224, using the access network 1202, the core network 1204, any intermediate network 1222, and possible further infrastructure (not shown) as intermediaries. The OTT connection 1224 may be transparent in the sense that the participating communication devices through which the OTT connection 1224 passes are unaware of routing of uplink and downlink communications. For example, the base station 1206 may not or need not be informed about the past routing of an incoming downlink communication with data originating from the host computer 1216 to be forwarded (e.g., handed over) to a connected UE 1212. Similarly, the base station 1206 need not be aware of the future routing of an outgoing uplink communication originating from the UE 1212 towards the host computer 1216.

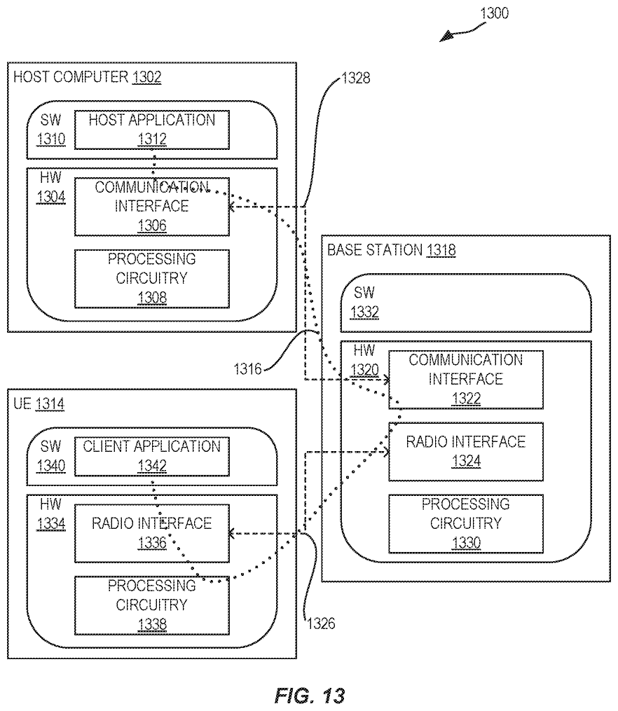

Example implementations, in accordance with an embodiment, of the UE, base station, and host computer discussed in the preceding paragraphs will now be described with reference to FIG. 13. In a communication system 1300, a host computer 1302 comprises hardware 1304 including a communication interface 1306 configured to set up and maintain a wired or wireless connection with an interface of a different communication device of the communication system 1300. The host computer 1302 further comprises processing circuitry 1308, which may have storage and/or processing capabilities. In particular, the processing circuitry 1308 may comprise one or more programmable processors, ASICs, FPGAs, or combinations of these (not shown) adapted to execute instructions. The host computer 1302 further comprises software 1310, which is stored in or accessible by the host computer 1302 and executable by the processing circuitry 1308. The software 1310 includes a host application 1312. The host application 1312 may be operable to provide a service to a remote user, such as a UE 1314 connecting via an OTT connection 1316 terminating at the UE 1314 and the host computer 1302. In providing the service to the remote user, the host application 1312 may provide user data which is transmitted using the OTT connection 1316.

The communication system 1300 further includes a base station 1318 provided in a telecommunication system and comprising hardware 1320 enabling it to communicate with the host computer 1302 and with the UE 1314. The hardware 1320 may include a communication interface 1322 for setting up and maintaining a wired or wireless connection with an interface of a different communication device of the communication system 1300, as well as a radio interface 1324 for setting up and maintaining at least a wireless connection 1326 with the UE 1314 located in a coverage area (not shown in FIG. 13) served by the base station 1318. The communication interface 1322 may be configured to facilitate a connection 1328 to the host computer 1302. The connection 1328 may be direct or it may pass through a core network (not shown in FIG. 13) of the telecommunication system and/or through one or more intermediate networks outside the telecommunication system. In the embodiment shown, the hardware 1320 of the base station 1318 further includes processing circuitry 1330, which may comprise one or more programmable processors, ASICs, FPGAs, or combinations of these (not shown) adapted to execute instructions. The base station 1318 further has software 1332 stored internally or accessible via an external connection.

The communication system 1300 further includes the UE 1314 already referred to. The UE's 1314 hardware 1334 may include a radio interface 1336 configured to set up and maintain a wireless connection 1326 with a base station serving a coverage area in which the UE 1314 is currently located. The hardware 1334 of the UE 1314 further includes processing circuitry 1338, which may comprise one or more programmable processors, ASICs, FPGAs, or combinations of these (not shown) adapted to execute instructions. The UE 1314 further comprises software 1340, which is stored in or accessible by the UE 1314 and executable by the processing circuitry 1338. The software 1340 includes a client application 1342. The client application 1342 may be operable to provide a service to a human or non-human user via the UE 1314, with the support of the host computer 1302. In the host computer 1302, the executing host application 1312 may communicate with the executing client application 1342 via the OTT connection 1316 terminating at the UE 1314 and the host computer 1302. In providing the service to the user, the client application 1342 may receive request data from the host application 1312 and provide user data in response to the request data. The OTT connection 1316 may transfer both the request data and the user data. The client application 1342 may interact with the user to generate the user data that it provides.

It is noted that the host computer 1302, the base station 1318, and the UE 1314 illustrated in FIG. 13 may be similar or identical to the host computer 1216, one of the base stations 1206A, 1206B, 1206C, and one of the UEs 1212, 1214 of FIG. 12, respectively. This is to say, the inner workings of these entities may be as shown in FIG. 13 and independently, the surrounding network topology may be that of FIG. 12.

In FIG. 13, the OTT connection 1316 has been drawn abstractly to illustrate the communication between the host computer 1302 and the UE 1314 via the base station 1318 without explicit reference to any intermediary devices and the precise routing of messages via these devices. The network infrastructure may determine the routing, which may be configured to hide from the UE 1314 or from the service provider operating the host computer 1302, or both. While the OTT connection 1316 is active, the network infrastructure may further take decisions by which it dynamically changes the routing (e.g., on the basis of load balancing consideration or reconfiguration of the network).

The wireless connection 1326 between the UE 1314 and the base station 1318 is in accordance with the teachings of the embodiments described throughout this disclosure. One or more of the various embodiments improve the performance of OTT services provided to the UE 1314 using the OTT connection 1316, in which the wireless connection 1326 forms the last segment. More precisely, the teachings of these embodiments may improve the e.g., data rate, latency, power consumption, etc. and thereby provide benefits such as e.g., reduced user waiting time, relaxed restriction on file size, better responsiveness, extended battery lifetime, etc.

A measurement procedure may be provided for the purpose of monitoring data rate, latency, and other factors on which the one or more embodiments improve. There may further be an optional network functionality for reconfiguring the OTT connection 1316 between the host computer 1302 and the UE 1314, in response to variations in the measurement results. The measurement procedure and/or the network functionality for reconfiguring the OTT connection 1316 may be implemented in the software 1310 and the hardware 1304 of the host computer 1302 or in the software 1340 and the hardware 1334 of the UE 1314, or both. In some embodiments, sensors (not shown) may be deployed in or in association with communication devices through which the OTT connection 1316 passes; the sensors may participate in the measurement procedure by supplying values of the monitored quantities exemplified above or supplying values of other physical quantities from which the software 1310, 1340 may compute or estimate the monitored quantities. The reconfiguring of the OTT connection 1316 may include message format, retransmission settings, preferred routing, etc.; the reconfiguring need not affect the base station 1318, and it may be unknown or imperceptible to the base station 1318. Such procedures and functionalities may be known and practiced in the art. In certain embodiments, measurements may involve proprietary UE signaling facilitating the host computer 1302's measurements of throughput, propagation times, latency, and the like. The measurements may be implemented in that the software 1310 and 1340 causes messages to be transmitted, in particular empty or ‘dummy’ messages, using the OTT connection 1316 while it monitors propagation times, errors, etc.

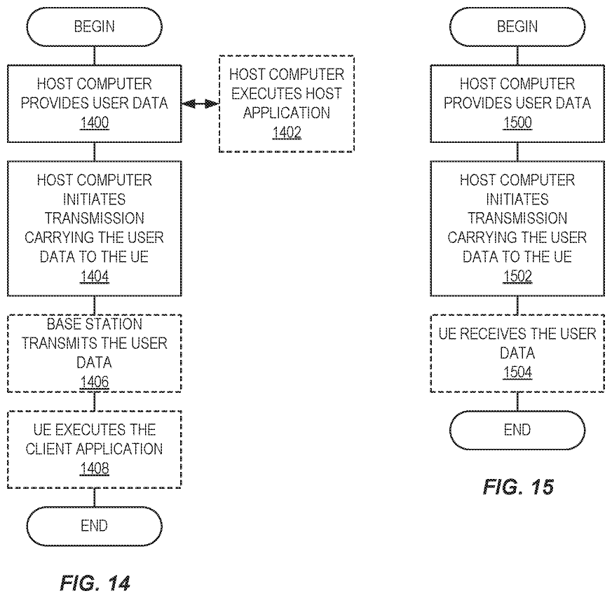

FIG. 14 is a flowchart illustrating a method implemented in a communication system, in accordance with one embodiment. The communication system includes a host computer, a base station, and a UE which may be those described with reference to FIGS. 12 and 13. For simplicity of the present disclosure, only drawing references to FIG. 14 will be included in this section. In step 1400, the host computer provides user data. In sub-step 1402 (which may be optional) of step 1400, the host computer provides the user data by executing a host application. In step 1404, the host computer initiates a transmission carrying the user data to the UE. In step 1406 (which may be optional), the base station transmits to the UE the user data which was carried in the transmission that the host computer initiated, in accordance with the teachings of the embodiments described throughout this disclosure. In step 1408 (which may also be optional), the UE executes a client application associated with the host application executed by the host computer.

FIG. 15 is a flowchart illustrating a method implemented in a communication system, in accordance with one embodiment. The communication system includes a host computer, a base station, and a UE which may be those described with reference to FIGS. 12 and 13. For simplicity of the present disclosure, only drawing references to FIG. 15 will be included in this section. In step 1500 of the method, the host computer provides user data. In an optional sub-step (not shown) the host computer provides the user data by executing a host application. In step 1502, the host computer initiates a transmission carrying the user data to the UE. The transmission may pass via the base station, in accordance with the teachings of the embodiments described throughout this disclosure. In step 1504 (which may be optional), the UE receives the user data carried in the transmission.

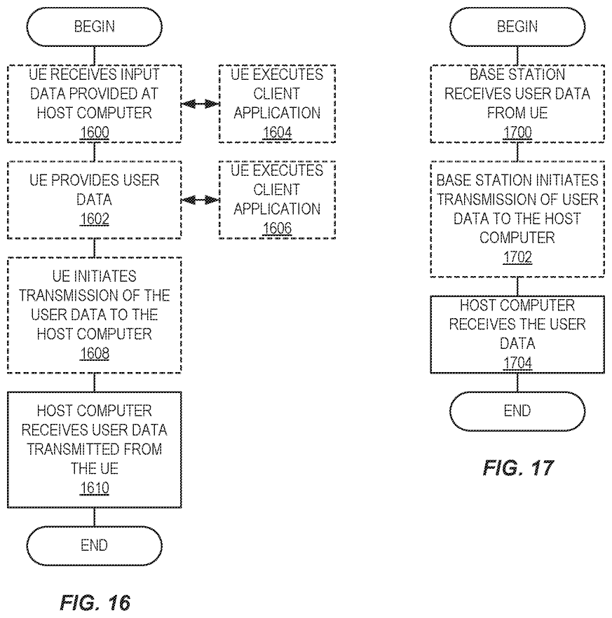

FIG. 16 is a flowchart illustrating a method implemented in a communication system, in accordance with one embodiment. The communication system includes a host computer, a base station, and a UE which may be those described with reference to FIGS. 12 and 13. For simplicity of the present disclosure, only drawing references to FIG. 16 will be included in this section. In step 1600 (which may be optional), the UE receives input data provided by the host computer. Additionally, or alternatively, in step 1602, the UE provides user data. In sub-step 1604 (which may be optional) of step 1600, the UE provides the user data by executing a client application. In sub-step 1606 (which may be optional) of step 1602, the UE executes a client application which provides the user data in reaction to the received input data provided by the host computer. In providing the user data, the executed client application may further consider user input received from the user. Regardless of the specific manner in which the user data was provided, the UE initiates, in sub-step 1608 (which may be optional), transmission of the user data to the host computer. In step 1610 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station, and a UE which may be those described with reference to FIGS. 12 and 13. For simplicity of the present disclosure, only drawing references to FIG. 17 will be included in this section. In step 1700 (which may be optional), in accordance with the teachings of the embodiments described throughout this disclosure, the base station receives user data from the UE. In step 1702 (which may be optional), the base station initiates transmission of the received user data to the host computer. In step 1704 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

The following information was included in the Appendix filed with the priority document.

The work item for IoT NTN enhancements in Rel-18 includes an objective to continue the standardization work about the topic of discontinuous coverage. Further enhancement to discontinuous coverage: Study and specify, if needed, mobility management enhancements and power saving enhancements for discontinuous coverage, taking into account the conclusions from the SA2 study FS_5GSAT_Ph2. [RAN2, RAN3].

In this paper we present our views on the signalling of the satellite assistance information that conveys the cell footprint and is used for predicting coverage gaps.

In Release 17, support of discontinuous coverage scenarios for IoT Non-Terrestrial Networks was enabled through a new set of parameters denominated Satellite Assistance Information (SAI) that are signalled in SIB32. This information is used by UEs to independently calculate when it is expected that their current location will be under satellite coverage again without excessive power consumption.

Observation 1: Satellite Assistance Information broadcast in SIB32 helps a UE estimate when it will regain NTN coverage in a discontinuous coverage scenario.

System Information was regarded as the best place to include this information on the base of two premises (see, R2-2203521, Discontinuous Coverage Open Issues Input, MediaTek Inc., RAN2 #117-e, March 2022): first, SAI might be common for most UEs in a cell, thus reducing unnecessary overhead, and second, this way is more efficient for UEs in RRC

Inactive/Idle mode, so that they don't need to transition to connected mode to obtain this information. However, System Information also presents some downsides, primarily with the inclusion of further modifications in the upcoming release. Thus, several companies proposed to include the additional possibility of sending SAI via dedicated RRC messages (R2-2200623, On Discontinuous coverage in IoT-NTN, MediaTek Inc, Sateliot, Gatehouse, RAN2 #116-bis-e, January 2021). For instance, this approach is relevant for a UE in connected mode that has failed to obtain SIB32, to reduce the acquisition frequency of SIB32 (more satellites can be included in a RRC message than in a SIB), or in certain mobility scenarios within the context of a discontinuous coverage deployment. Although it was initially agreed in R2-2203521 to further study these cases, later in (R2-2205933, Email Discussion Report [Post117-e][906] [IoT-NTN], MediaTek Inc, RAN2 #118-e, May 2022), it was decided to postpone the discussion to Release 18 due to time shortage.

Observation 1: Dedicated signalling of Satellite Assistance Information offers more flexibility than System Information and helps reduce the acquisition frequency of SIB32.

Proposal 1: Introduce dedicated signalling of Satellite Assistance Information.

In spite of the predictability of satellite movements, discontinuous coverage introduces a higher level of uncertainty into the system. The mechanism specified in Release 17 relies on the capability of UEs to accurately estimate the duration of coverage gaps from the satellite assistance information provided by the network. For the quasi-Earth fixed cell scenario, the network provides a definite UTC time offset boundary (t-ServiceStart-r17). In the case of Earth-moving cell scenario, the network transmits a coarse average ephemeris encoded in Two-Line Element (TLE) format for the UEs to autonomously estimate the next satellite's start serving time. Clearly, the latter involves a degree of unpredictability, compared to the former, and a characterization of the estimation error has already been discussed in previous contributions.

Observation 3: An increase in uncertainty is associated with discontinuous coverage, especially for Earth moving cells.

UE isn't expected to be served by any NTN cell when the current time is earlier than the next satellite's start serving time. As previously mentioned, this value could have been either calculated with t-ServiceStart-r17 or estimated with the provided TLE ephemeris. Thus, UE is not expected to start the cell (re) selection procedure, or more generally, any AS idle mode task related to NTN [ ] before this time. Once under NTN coverage, a UE may start cell selection without any prior knowledge, besides stored information, of which RF channels are E-UTRA or the location of NB-IoT carriers. For a UE, this may lead to increased delays and power consumption. For the network, it becomes highly uncertain when a UE might re-gain uplink synchronization potentially leading to missed paging occasions.

Observation 4: From network perspective, it is uncertain when a UE regains uplink synchronization after an NTN coverage gap. This could lead to missed paging occasions.

Observation 5: From the UE perspective, it is uncertain the characteristics of the upcoming cell after an NTN coverage gap. This could lead to increased delays, measurement duration and, ultimately, power consumption in the UE.

A feasible assumption is that NTN deployments, especially those with discontinuous coverage, may take advantage of some degree of configuration commonality between cells. For simplicity and resource economy, an incoming cell after a coverage gap may re-use the same configuration as the previous cell. In this way, the system could toggle between several of a limited number of configuration options. FIG. 6 illustrates such scenario as a function of time. UE at T₀ is camping on a quasi-Earth fixed NTN cell named “Cell A” and served by satellite Sat_{N}. This is followed by a period without NTN service (an NTN coverage gap) with a duration of T₁-T₀. There is a high probability that the same UE at T₁ camps on the same cell named “Cell A” (or a different one but with similar configuration) and now served by the next satellite Sat_{N+1}. Knowing this information (i.e., the relation between the cell before coverage gap and after coverage gap) is beneficial to the UE which can leverage the similarity between cells to accelerate measurements and re-gain uplink sync in a more efficient manner after a coverage gap.

Observation 6: When it comes to deployment, it is likely that similar configurations will exist between cells before and after the occurrence of an NTN coverage gaps.

Observation 7: A UE can leverage similarity between cells before and after an NTN coverage gap to reduce service interruption and power consumption.

In NR NTN, neighbour satellite information in SIB19 includes, among other things, ephemeris, and cell measurement assistance information, i.e., PCI and carrier frequency. In contrast, the present contents of SIB32 in IoT NTN only encompasses satellite and coverage related information. This is not sufficient for a UE to determine the existence of configuration similarity between cells before and after an NTN coverage gap. Accordingly, in the same manner as NR NTN, the network could include additional measurement assistance information, such as PCI or carrier frequency, in SIB32 to assist UEs in accelerating measurements and re-gaining uplink sync more efficiently after a coverage gap.

Proposal 2: Measurement assistance information, i.e., PCI or carrier frequency, is provided in SIB32 to facilitate measurements and a faster uplink sync and ensure minimal disruption to paging reception after an NTN coverage gap.

### EMBODIMENTS

### Group A Embodiments

Embodiment 1: A method performed by a User Equipment, UE, for adapting one or more measurement procedures, the method comprising one or more of: obtaining Cell Assistance Information, CAI; determining whether at least two cells of a plurality of cells meet one or more Measurement Similarity, MS, conditions; adapting one or more measurement procedures based on whether or not the one or more MS conditions is met; and if cells do not meet an MS condition, obtaining information about at least one cell.

Embodiment 2: The method of the previous embodiment wherein a first cell (Cell1) of the plurality of cells is served or managed by a first network node (NW1) and a second cell (Cell2) of the plurality of cells is served or managed by a second network node (NW2).

Embodiment 3: The method of any of the previous embodiments wherein the UE is served by Cell1 and Cell2 are different times.

Embodiment 4: The method of any of the previous embodiments wherein Cell1 stops serving the area or zone where the UE is located at a time instance (T-service) and Cell2 starts serving the area or zone where the UE is located from time instance (T-service-start).

Embodiment 5: The method of any of the previous embodiments wherein obtaining the CAI comprises one or more of: receiving system information of the cell; based on historical data or statistics; based on pre-defined rule (e.g., type of satellite, satellite speed, UE location, time of the day).

Embodiment 6: The method of any of the previous embodiments wherein determining whether the at least two cells of a plurality of cells meet one or more MS conditions comprises: based on one or more pre-defined rules and/or by receiving information from a network node (e.g., from NW1 via signaling).

Embodiment 7: The method of any of the previous embodiments wherein the at least two cells are considered similar provided that one or more of the following criteria are met: a. Cell1 and Cell2 are operated by a network node, which may be the same or different satellites; b. Cell1 and Cell2 are operated by the same type of satellite (e.g., by the LEO satellite); c. Cell1 and Cell2 are operated by the same satellite; d. Cell1 and Cell2 are associated with the same cell ID (e.g., PCI, CGI etc.); e. Cell1 and Cell2 operate on or belong to the same carrier frequency; f. the spatial distance between the satellite operating Cell 1 and the satellite operating Cell2 at T-service-start are closer than a threshold; and g. UE receives information sent by NW1 directly indicating Cell1 and Cell2 meeting MS condition.

Embodiment 8: The method of any of the previous embodiments wherein obtaining information about the at least one cell comprises one or more of: obtaining the information based on a pre-defined rule or by receiving the information from a network node (e.g., from SI sent by NW1).

Embodiment 9: The method of any of the previous embodiments wherein the information comprises one or more of the following: cell ID of Cell2; carrier frequency of Cell2; and indication about type of cell (e.g., whether operated by TN, NTN, or ATG node).

Embodiment 10: The method of any of the previous embodiments wherein Cell1 and Cell2 meet MS condition provided Cell2 which starts service from T-service-start is the same cell as the current serving cell (Cell1).

Embodiment 11: The method of any of the previous embodiments wherein, if Cell1 and Cell2 meets at least one MS condition then the UE starts searching the cells starting from time instance from Tservice-start+M1.

Embodiment 12: The method of any of the previous embodiments wherein, if Cell1 and Cell2 do not meet any MS condition then the UE starts searching the cells starting from time instance Tservice-start+M2.

Embodiment 13: The method of any of the previous embodiments wherein the UE may also identify at least one cell (e.g., Cell2) within Tsearch-start+Tsi+M3 starting from Tservice-start+M2.

Embodiment 14: The method of any of the previous embodiments wherein one or more of the plurality of cells are served by network nodes from the group consisting of: an NTN, an IoT NTN, an NR NTN, a TN network, and an ATG network.

Embodiment 15: The method of any of the previous embodiments, further comprising: providing user data; and forwarding the user data to a host computer via the transmission to the base station.

### Group B Embodiments

Embodiment 16: A method performed by a base station, the method comprising one or more of: determining whether at least two cells of a plurality of cells (e.g., Cell1 and Cell2) meet one or more Measurement Similarity, MS, conditions; and transmitting the determined information to a User Equipment, UE; transmitting the message related to Cell1 and Cell2 meeting MS condition or not meeting MS condition to the UE; transmitting information about cell2 to the UE (e.g., cell ID of Cell2, carrier frequency of Cell2, indication about type of cell (e.g., whether operated by TN, NTN or ATG node).

Embodiment 17: The method of the previous embodiment including any of the features from the Group A Embodiments.

Embodiment 18: The method of any of the previous embodiments, further comprising: obtaining user data; and forwarding the user data to a host computer or a wireless device.

### Group C Embodiments

Embodiment 19: A wireless device for adapting one or more measurement procedures, the wireless device comprising: processing circuitry configured to perform any of the steps of any of the Group A embodiments; and power supply circuitry configured to supply power to the wireless device.

Embodiment 20: A base station, the base station comprising: processing circuitry configured to perform any of the steps of any of the Group B embodiments; and power supply circuitry configured to supply power to the base station.

Embodiment 21: A User Equipment, UE, for adapting one or more measurement procedures, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 22: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 23: The communication system of the previous embodiment further including the base station.

Embodiment 24: The communication system of the previous 2 embodiments, further including the UE, wherein the UE is configured to communicate with the base station.

Embodiment 25: The communication system of the previous 3 embodiments, wherein: the processing circuitry of the host computer is configured to execute a host application, thereby providing the user data; and the UE comprises processing circuitry configured to execute a client application associated with the host application.

Embodiment 26: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 27: The method of the previous embodiment, further comprising, at the base station, transmitting the user data.

Embodiment 28: The method of the previous 2 embodiments, wherein the user data is provided at the host computer by executing a host application, the method further comprising, at the UE, executing a client application associated with the host application.

Embodiment 29: A User Equipment, UE, configured to communicate with a base station, the UE comprising a radio interface and processing circuitry configured to perform the method of the previous 3 embodiments.

Embodiment 30: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 31: The communication system of the previous embodiment, wherein the cellular network further includes a base station configured to communicate with the UE.

Embodiment 32: The communication system of the previous 2 embodiments, wherein: the processing circuitry of the host computer is configured to execute a host application, thereby providing the user data; and the UE's processing circuitry is configured to execute a client application associated with the host application.

Embodiment 33: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 34: The method of the previous embodiment, further comprising at the UE, receiving the user data from the base station.

Embodiment 35: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 36: The communication system of the previous embodiment, further including the UE.

Embodiment 37: The communication system of the previous 2 embodiments, further including the base station, wherein the base station comprises a radio interface configured to communicate with the UE and a communication interface configured to forward to the host computer the user data carried by a transmission from the UE to the base station.

Embodiment 38: The communication system of the previous 3 embodiments, wherein: the processing circuitry of the host computer is configured to execute a host application; and the UE's processing circuitry is configured to execute a client application associated with the host application, thereby providing the user data.

Embodiment 39: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 40: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 41: The method of the previous embodiment, further comprising, at the UE, providing the user data to the base station.

Embodiment 42: The method of the previous 2 embodiments, further comprising: at the UE, executing a client application, thereby providing the user data to be transmitted; and at the host computer, executing a host application associated with the client application.

Embodiment 43: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 44: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 45: The communication system of the previous embodiment further including the base station.

Embodiment 46: The communication system of the previous 2 embodiments, further including the UE, wherein the UE is configured to communicate with the base station.

Embodiment 47: The communication system of the previous 3 embodiments, wherein: the processing circuitry of the host computer is configured to execute a host application; and the UE is configured to execute a client application associated with the host application, thereby providing the user data to be received by the host computer.

Embodiment 48: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 49: The method of the previous embodiment, further comprising at the base station, receiving the user data from the UE.

Embodiment 50: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
ATG Air-to-Ground
AUSF Authentication Server Function
CAI Cell Assistance Information
CPU Central Processing Unit
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
GNSS Global Navigation Satellite System
HSS Home Subscriber Server.
IoT Internet of Things
IP Internet Protocol
LTE Long Term Evolution.
MME Mobility Management Entity
MS Measurement Similarity
MTC Machine Type Communication
NEF Network Exposure Function
NF Network Function
NR New Radio
NRF Network Function Repository Function
NSSF Network Slice Selection Function.
NTN Non-Terrestrial Network
OTT Over-the-Top
PC Personal Computer
PCF Policy Control Function
P-GW Packet Data Network Gateway
QoS Quality of Service
RAM Random Access Memory
RAN Radio Access Network
ROM Read Only Memory
RRH Remote Radio Head
RTT Round Trip Time
SCEF Service Capability Exposure Function
SMF Session Management Function
TN Terrestrial Network
UDM Unified Data Management
UE User Equipment.
UPF User Plane Function

Those skilled in the art will recognize improvements and modifications to the embodiments of the present disclosure. All such improvements and modifications are considered within the scope of the concepts disclosed herein.

1. A method performed by a User Equipment (UE) for adapting one or more operational procedures, the method comprising:
determining, based on cell assistance information, whether at least two cells of a plurality of cells meet one or more measurement similarity conditions; and
in response to determining that the at least two cells of the plurality of cells meet the one or more measurement similarity conditions, adapting the one or more operational procedures.

2. The method of claim 1, wherein the cell assistance information comprises a carrier frequency of the plurality of cells.

3. The method of claim 1, further comprising:
obtaining the cell assistance information.

4. The method of claim 3, wherein obtaining the cell assistance information comprises:
obtaining the cell assistance information in a System Information broadcast.

5. The method of claim 4, wherein obtaining the cell assistance information comprises:
obtaining the cell assistance information in a SystemInformationBlockType32.

6. The method of claim 1, wherein a first cell of the plurality of cells is served or managed by a first network node and a second cell of the plurality of cells is served or managed by a second network node.

7. The method of claim 6, wherein the UE is served by the first cell and the second cell at different times.

8. The method of claim 6, wherein the first cell stops serving the area or zone where the UE is located at a first time instance and the second cell starts serving the area or zone where the UE is located from a second time instance.

9. The method of claim 6, wherein determining whether the at least two cells of the plurality of cells meet the one or more measurement similarity conditions is based on one or more of:
the first cell and the second cell are operated by a network node, which may be the same or different satellites;
the first cell and the second cell are operated by a same type of satellite;
the first cell and the second cell are operated by a same satellite;
the first cell and the second cell are associated with a same cell identifier;
the first cell and the second cell operate on or belong to a same carrier frequency;
a spatial distance between a satellite operating the first cell and a satellite operating the second cell at the second time instance are closer than a threshold; and
the UE receives information sent by the first network node directly indicating that the first cell and the second cell meet the measurement similarity condition.

10. The method of claim 6, wherein the cell assistance information comprises one or more of:
a cell identifier of the second cell;
carrier frequency of the second cell; and
indication about type of cell.

11. The method of claim 1, wherein one or more cell of the plurality of cells are served by a network node from the group consisting of:
a Non-Terrestrial Network (NTN);
an Internet of Things (IoT) NTN;
a New Radio (NR) NTN;
a Terrestrial Network (TN) network; and
an Air-To-Ground (ATG) network.

12. The method of claim 1, wherein the one or more operational procedures comprises at least one of:
a measurement procedure;
a radio link operation;
a cell change;
a channel monitoring or reception procedure; or
a Global Navigation Satellite System (GNSS) acquisition.

13. A method performed by a network node, the method comprising:
determining cell assistance information that can be used to determine whether at least two cells of a plurality of cells meet one or more measurement similarity conditions; and
transmitting, to a User Equipment (UE) the cell assistance information.

14. The method of claim 13, wherein the cell assistance information comprises a carrier frequency of the plurality of cells.

15. The method of claim 13, wherein transmitting the cell assistance information comprises:
transmitting the cell assistance information in a System Information broadcast.

16. The method of claim 15, wherein transmitting the cell assistance information comprises:
transmitting the cell assistance information in a SystemInformationBlockType32.

17. The method of claim 13, wherein the cell assistance information facilitates a cell change from a first cell to a second cell, and wherein the cell assistance information comprises one or more of:
a cell identifier of the second cell;
a carrier frequency of the second cell; and
an indication about type of cell.

18. The method of claim 13, wherein the network node operates in one of the group consisting of:
a Non-Terrestrial Network (NTN);
an Internet of Things (IoT) NTN;
a New Radio (NR) NTN;
a Terrestrial Network (TN) network; and
an Air-To-Ground (ATG) network.

19. A User Equipment (UE) comprising processing circuitry and memory, the memory comprising instructions to cause the UE to:
determine, based on cell assistance information, whether at least two cells of a plurality of cells meet one or more measurement similarity conditions; and
in response to determining that the at least two cells of the plurality of cells meet the one or more measurement similarity conditions, adapt one or more operational procedures.

20. (canceled)

21. (canceled)

22. A network node comprising processing circuitry and memory, the memory comprising instructions to cause the network node to:
determine cell assistance information that can be used to determine whether at least two cells of a plurality of cells meet one or more measurement similarity conditions; and
transmit, to a User Equipment (UE) the cell assistance information.

23. (canceled)

24. (canceled)
